(19) United States
(12) Patent Application Publication
(10) Pub. No.: US 2009/0147298 A1
(43) Pub. Date: Jun. 11, 2009

(54) Image reading device and printing system

(75) Inventors: Junji Takahashi, Yokohama-shi (JP); Kazuo Nakano, Tokyo (JP); Koichi Hashimoto, Tokyo (JP)

Correspondence Address: OLIFF & BERRIDGE, PLC, P.O. BOX 320850, ALEXANDRIA, VA, 22320-4850, US

(73) Assignee: RISO KAGAKU CORPORATION, TOKYO (JP)

(21) Appl. No.: 11/990,920

(22) PCT Filed: Oct. 16, 2006
(86) PCT No.: PCT/JP2006/320982

§ 371 Date: Feb. 25, 2008

(30) Foreign Application Priority Data
Oct. 17, 2005 (JP) 2005 302299
Jun. 28, 2006 (JP) 2006 178606

(51) Int. Cl. G06F 3/12

(52) U.S. Cl. 358/1.15

(57) ABSTRACT

Image reading device, when connected directly with a printer supporting a predetermined communications standard, enables the printer to print an image with a size or a layout desired by a user, irrespective of the internal setting of the printer. The inventive devices comprises an image detecting portion reading an original image, an image data generating portion generating an original image data, an image data outputting portion which outputs an image data with a communication mode which can be received by a printer supporting a predetermined communication standard and which renders an image represented by the image data printable with the printer, and an image modification processing portion modifying the original image data based on an image data for modification obtained by reading a reference image containing a predetermined pattern printed through the printer, and thereby an original image will printed with a desired size or a desired layout.

### FIELD OF THE INVENTION

The present invention relates to an image reading device which generates an image data through reading an image drawn on a paper sheet, a plastic sheet or other media, and outputs the image data. More specifically, the present invention relates to an image reading device which is designed so as to transmit an image data directly to a printer, enabling the printer to print an image without using a personal computer (PC). Further, the present invention also relates to a printing system comprising an image reading device as described above and a printer receiving an image data therefrom and printing an image on a printing medium, such as a printing paper.

### BACKGROUND OF THE INVENTION

Together with the prevalence of PCs, image reading devices, such as image scanners, have been used as peripheral devices for PCs in offices, households, etc. more inexpensively and easily than ever. When an image reading device and a printer are connected with a PC, an image on a paper sheet or other media can be easily acquired into a PC as an electronized image data and duplicated or printed on a printing medium. Thus, at present, anyone else has become able to produce, relatively easily in his home or office, various printed matters, such as New Year's cards, season greetings, Christmas cards, handbills, flyers, which must be prepared one by one by handwriting, patching, stamping, etc. or by ordering a professional printing service in the past. Moreover, according to the technological development of image sensors in image reading devices and ink-jet systems in printers, images read with an image reading device and printed with a printer are qualitatively comparable with a film photo. Furthermore, by using a suitable application or software extensively, the editing of an image can also be freely performed on a PC.

In the duplication and printing of images using a PC together with an image reading device and a printer, the whole processes are executed under the control of the PC. However, as compared with image reading devices and printers, PCs are expensive, and may be rather high-end devices for users who intend to duplicate and print an image originally drawn on a paper sheet, etc., e.g. preparation of New Year's cards or else. Further, to operate a PC may be often troublesome and difficult for users who have been preparing New Year's cards, etc. by handwriting and patching or by using a small mimeograph duplicator, etc. Thus, in Japanese Patent Laid-open publications Nos. JP 2004-104665, 2005-22307, 2005-22836, 2005-27140 and 2005-27141, filed by the same assignee of the present application, there have been proposed an image reading and printing system comprising an image reading device and a printer (a postcard preparing apparatus), wherein, without a PC, an image is read with the image reading device, and directly outputted to the printer and printed therewith. In such an image reading and printing system, an image in a drawing or a manuscript prepared by handwriting and/or patching, etc. is read with the image reading device, and a duplicated copy of the image is printed only through simple or easy button operation, so that not only the system is far less expensive than when a PC is used, but also even the generation, not familiar with PCs, or children can relatively easily enjoy the duplication and printing of New year's cards, postcards, invitation cards for a birthday party or a Christmas party, etc.

By the way, in the market of PCs for household and office use, many manufacturers have manufactured and sold various types and models of PCs, image reading device and printers as peripheral equipment for PCs. From those various PCs and/or peripheral equipment, consumers can choose favorite ones, taking into account the performances, prices, etc. thereof. Communication systems or modes between those PCs and peripheral equipment, equipped thereon, are designed to follow or support a predetermined communication standard, and accordingly, for instance, it is possible to use a scanner of company B and a printer of company C by connecting them to a PC of company A. Especially for communication between printers and digital cameras, there is proposed a communication standard, such as Pictbridge, enabling the printing of an image data of a predetermined image format only by transmitting the data from a digital camera to a printer. Thus, if both camera and printers support such a common communication standard, the printing of a photograph captured with any camera will be available without using a PC. Accordingly, in an image reading and printing system, such as postcard preparing apparatus, as mentioned above, by equipping an image reading device with a communication system of supporting such a predetermined communication standard that enables the printing of an image through direct transmission of an image data to a printer, an arbitrary printer supporting the common predetermined communication standard could be used.

However, even when such a predetermined communication standard enabling the print of an image through direct transmission of an image data to a printer is employed in an image reading device, an image is not always printed on a printing medium (a paper sheet, a plastic sheet, etc.) in a manner expected by a user.

A digitized image data, usually, is a set of pixels each having a brightness value (in a color image, brightness values for the respective color components, e.g. R, G, B) and coordinate data. Thus, when a image data is transmitted to a printer for printing an image, it is required to specify the number of pixels deposited on a printing medium per unit length (in other words, the size of the area on the printing medium to which an individual pixel in the image data is assigned) or the size of the image on the printing medium. In most of printers supporting a communication standard designed mainly for printing photograph images taken with a digital camera, such as PictBridge, however, the number of pixels per unit length on a printing medium or the size of an image on a printing medium is automatically determined in a printer so that the size of an image on a printing media can not be changed or adjusted by a user. In particular, when so-called “margin-less printing”, namely, a mode in which an image is printed on the whole surface of a printing medium without margin, is executed to print an image in such a printer through the direct reception of an image data from a digital camera, etc., the image corresponding to an image data received in a printer is printed on a printing medium under a condition that the size of an image is set to be a little larger than the printing medium, namely, the edges of the image corresponding to the received image data extend out of the printing medium, as shown in the lower drawing in FIG. 13 (In an ink-jet type printer, print ink is sprayed to the outermost edge of the printing medium by moving the ink-jet portion beyond the edge of the printing medium. See e.g. JP 2003-274155). Accordingly, in “margin-less printing”, if an image data as it is just prepared by reading an original image with an image reading device is transmitted to a printer, the periphery of the original image is cut away from the resultant printed image, and, if the printing medium has the same size as the original drawing, the printed image will be magnified relative to the original image (see the lower in FIG. 13). However, a user cannot adjust the width and direction of peripheral portions of the image extending beyond the edge of the printing medium, or, the size and position of the region, to be printed on the printing medium, in the image data transmitted to the printer [It is possible that the center of a transmitted image data always deviates form the center of a printing medium due to errors in size of a printing medium, in feeding a printing medium in a printer]. Further, the width and direction of periphery portions of an image extending beyond the edge of a printing medium vary with models of printers.

It is very inconvenient and unpleasant for a user of an image reading device that neither the region to be printed on a printing medium within an image transmitted from the image reading devices nor the size of an image on a printing medium is adjustable by himself. Upon printing New year's cards, Christmas cards, etc., the users of the image reading and printing systems like the postcard preparing apparatus as described above, in general, expect that their original drawing will be duplicated or printed as just it is. However, if an actually printed image is different in size from an original one, or if its periphery is unintentionally cut away from a printed image, the users would feel very unpleasant. Further, in order to print an image in an original drawing as he expects without such unintentional cutting away of the periphery of the image, the adjustment of the size and position of the image on the original drawing is required, but it is very cumbersome to consider the internal setting of a printer during preparing the original drawing by handwriting, patching, or else and/or to re-prepare the original drawing having been prepared on a paper sheet. Of course, enlargement, diminution and layout adjustment of an image are possible if the image is acquired into a PC. In that case, however, the purpose of the image reading and printing system that the duplication and printing of New Year's cards, etc. can be done relatively easily even by the generation and/or children not familiar with PC's operation would not be achieved.

Accordingly, if it is possible to print an image through transmitting an image data from an image reading device directly to any printer without a PC, and also, the image is printed as expected by a user without unintentional cutting away of the peripheries of the image, the duplication and printing of various images will become easier and simpler than ever. In this connection, considering the situation of duplication and printing of an original copy of New Year's cards or Christmas cards, it is preferable that an image can be printed in the substantially same size as its original image. Further, it is preferable that the operations of a user are easy upon printing an image with such an image reading device.

### SUMMARY OF THE INVENTION

One of the objects of the present invention is to provide an image reading device being able to communicate directly with any printer supporting a predetermined communication standard and to print an image, acquired by the image reading device, with the printer, wherein, irrespective of the internal setting of the printer, the image is printed on a printing medium with any size and/or any layout intended, expected or requested by a user. In this connection, in the followings, an image appearing on an original copy or an original drawing is referred to as an “original image”; a data representing an image is referred to as an “image data”. A region to be printed on a printing medium within an image or an image data transmitted or to be transmitted to a printer is referred to as a “print region” (See the upper right in FIG. 13).

The inventive image reading device, generally, comprises an image detecting portion which generates a signal representing an image on an original copy by optically reading it; an image data generating portion which generates an image data based on the signal representing the original image; and an image data outputting portion which outputs the image data with a communication mode receivable by any printer supporting a predetermined communication standard and enabling the printer to receive the image data and to print an image corresponding to the image data. Thus, according to the present invention, an image, acquired with the image reading device, can be printed with any printer supporting the communication mode of the image data outputting portion without using a PC. In this connection, it should be understood that, although the inventive image reading device is typically of the type of an image scanner which reads an image by scanning an original copy with the image detecting portion moving automatically, the inventive device may be of the type of a handy scanner in which an image detecting portion is moved with a user's hand, or any other type of image reading devices.

Further, the inventive image reading device may include an image modification processing portion which modifies an image data generated by reading the original copy (an original image data) based upon an “image data for modification”, which is generated with the image generating portion through reading with an image detecting portion a printed reference image printed on a printing medium with the printer to which a reference image data representing a reference image including a predetermined pattern is outputted from the image data outputting portion.

As described above, when an image data, i.e. a set of pixels, representing an image acquired by an image reading device is transmitted to a printer and printed therewith, the print region (actually printed on a printing medium within the transmitted image data) or the number of pixels (of the transmitted data) per unit length on the printing medium is determined in accordance with the internal setting of the printer. In other words, how an image, acquired by an image reading device, is printed with a printer will be known for a user only after the image has been actually printed. In such a manner, it is possible that an image created on an original copy by handwriting or patching, etc. would become useless owing to that the printing is not performed as expected by a user.

So, the inventive image reading device is designed to be able to output a reference image data representing a reference image containing a predetermined pattern to a printer connected with image reading device; to command the printer to print a printed image of the reference image (a printed reference image); to capture the printed reference image through an image detecting portion; and to acquire the information of how the printer prints its received image data, i.e. the information of the internal setting of the printer, with the image modification processing portion, prior to the printing of an original image. In the image data obtained by reading the printed image of the reference image, i.e. an image data for modification, there is reflected the internal setting of the printer with respect to the region actually printed on a printing medium within the image data received by the printer or the number of pixels per unit length in printing the received image data on a printing medium. Thus, by analyzing the image data for modification in order to grasp the internal setting of the printer, and by transmitting to the printer the image data (a modified original image data) generated through the modification of an original image data based on the result of the analysis of the image data for modification, it becomes possible to make a printed image having a size or a layout desired or requested by a user. In this connection, whether or not the modification of an image data to be transmitted is executed may be selectively determined (Otherwise, the printing of the reference image for acquiring an image data for modification would become unavailable.).

As one of aspects for acquiring the information of an internal setting of a printer, the above-mentioned image modification processing portion is designed to detect a region, printed on a printing medium with a printer, within an image represented by the reference image data outputted from the image data outputting portion, based on the reference image data and image data for modification, and an original image data may be modified based on the information of the detected region.

In margin-less printing mode of a printer which can operate while being directly connected to the inventive image reading device, if the printer receives an image data of a certain dimension (Hereafter, “the dimension of an image data” indicates the number of pixels in the lengthwise (vertical) and crosswise (horizontal) direction of an image data), the printer sets a size of an image to be printed or the number of pixels per unit length of the received image data in accordance with the internal setting of the printer's own, and therefore, only a certain region of the received image data will be printed on a printing medium. Since the above-mentioned image data for modification indicates a region actually printed on a printing medium (print region) of a reference image data transmitted to this printer, a print region in an images corresponding to a transmitted image data can be detected by comparing the reference image data with the image data for modification. Thus, by modifying an original image so as to confine the original image or to arrange and assign the original image with a desired layout within the range of the print region of an image data to be transmitted to a printer, and then transmitting so modified image data to a printer, unintentional cutting off of the periphery and/or sizing of the original image will be avoided in the resultant printed image, and thereby, a user need not care about the internal setting of a printer during the preparation of an original copy.

In the modification of an original image data based on the information on the region printed on a printing medium as described above, the original image data may be modified based on the ratio between the dimension of the reference image data outputted from the image data outputting portion and that of the print region of the outputted image data. The dimension of the reference image data corresponds to the whole dimension of the image data outputted from the image reading device, and the dimension of the print region of the reference image data corresponds to the dimension of the actually printed region of the image data outputted from the image reading device. Thus, by adjusting the dimension of the original image data in an image data to be transmitted to a printer based on the dimension ratio between the reference image data and the print region thereof, it becomes enabled to print an image of a desired size on a printing medium. Moreover, the position of the print region in the reference image represented by the reference image data indicates the position of the region actually appearing on a printing medium within the image data transmitted to the printer. Thus, by adjusting the position of an original image data in an image data to be transmitted to a printer based upon the position of the print region in the reference image, it becomes enabled to print an image in a targeted position on a printing medium. In this connection, whether both the size ratio and position of the print region are used or either one of those is used in the modification may be appropriately determined according to the manufacturing cost of the device, the necessity for compensation processing, etc.

By the way, a printer available in the market, in most cases, prints an image represented by an image data that the printer receives at a substantially uniform number of pixels (of the image data) per unit length on a printing medium (It is possible that the aspect ratio of an printed image is different.). Thus, the number of pixels per unit length or a print region of the image data received by the printer on a printing medium will be found by detecting or analyzing a size and a position of a predetermined pattern in an image represented by a reference image data on a printed medium. Accordingly, in one of embodiments of the inventive device, the image modification processing portion may be designed to modify an original image data based on the dimension of a predetermined pattern in the reference image data and that of a pattern in the image data for modification corresponding to the predetermined pattern in the reference image and/or the position of the predetermined pattern in the reference image data and that of the pattern in the image data for modification corresponding to the predetermined pattern in the reference image. Such a predetermined pattern, for example, may be a figure confined within a print region or a printing medium when the figure is printed thereon. However, a pattern partially protruding beyond the print region may also be employed if the whole dimension and shape of the pattern can be obtained from the portion appearing on a printing medium. Further, for such a pattern, a figure enabling the detection of the width of the periphery cut off from a printing medium may be employed.

In one embodiment of the present invention, upon generating a modified original image data through the modification of an original image data by means of a reference image data having a predetermined pattern and an image data for modification obtained from the printed image as described above, the ratio between the dimension of the predetermined pattern in the reference image data and that of the printed image of the predetermined pattern in the image data for modification (hereinafter, referred to as a “scaling factor”) and the distance between the position of the predetermined pattern in the reference image data and the position of the printed image of the predetermined pattern in the image data for modification (hereafter, referred to as “shifting amount”) are calculated, and these ratio and distance will be used as “modifying parameters” for modifying an original image data to generate a modified original image data.

These “scaling factor” and “shifting amount” are the amounts obtained from the image resulting from the printing of a reference image data under a condition where a print region of the reference image data transmitted to the printer is made coincide with a printing medium. Thus, by means of these parameters, a dimension and a position of the print region in an image data received by a printer can be found, and thus, the preparation of an image data to be transmitted to a printer (a modified original image data) becomes enabled such that an image read with the image reading device or an image to be printed on a printing medium is assigned to or appropriately arranged in, the print region (See the following notes). Then, when the resultant modified original image data are transmitted to the printer, the image represented by the whole modified original image data is adjusted in the printer so as to extend beyond a printing medium, and thereby the print region of the modified original image data will be set to coincide with the printing medium, so that an image of a size or a layout desired by a user will be printed on the printing medium. In this connection, it should be understood that a modified original image data may be prepared directly based upon an image data to be printed on a printing medium and modifying parameters, without computing the dimension and position of a print region. [Note: When the dimension of a reference image data is equal to the dimension of an image data obtained by reading an image of the same size as a printing medium with the image detecting portion and generating the resultant signal of the image with the image data generating portion, the “scaling factor” is equivalent to the inverse of the ratio of the dimension of the print region of the transmitted image data to the dimension thereof, and “Shifting amount” is equivalent to the distance between the center of the transmitted image data and the center of the print region of the image data multiplied by the “scaling factor.” If the dimension of the reference image data differs from the dimension of the image data generated by an image detecting portion, or, if the reading region of the image detecting portion differs from the dimension of a printing medium, the print region in a transmitted image data can be specified by calculating the ratio of the dimension of the print region of the transmitted image data to the dimension thereof and the distance between the center of the transmitted image data and the center of the print region thereof through converting the above-mentioned modifying parameters by means of the dimension of a reference image data, the dimension (absolute size) of a printing medium, a resolution at the time of image reading of an image detecting portion, etc.]

In the image modification processing portion, a reference image data may be memorized in a reference image data memory portion, or may be generated by reading a prepared reference image copy with the image detecting portion. The former case is advantageous in that, until acquiring image data for modification, a user only needs to set a printed reference image on the reading region of the image reading device and push a button several times while the latter is advantageous in that a storage portion for a reference image data can be omitted.

In the inventive image reading device as described above, after acquiring an image data for modification, a modified original image data is generated, in which an image to be printed on a printing medium is assigned to a print region therein. To make such a modified original image data, in one embodiment, a “pasteboard image data” is generated, on which an original image data will be pasted. Here, “Pasteboard image data” is an image data defining the whole region of an image represented by an image data to be transmitted from the image data outputting portion to a printer. Further, for another embodiment of generating a modified original image data from an original image data, a frame data may be added to the periphery of the original image data. In both of the above cases, an image data to be transmitted from an image data outputting portion, i.e., a modified original image data, is so prepared that an original image data has been arranged in, or assigned to, the print region in order to print the original image of a size or a layout requested by a user on a printing medium. When the modified original image data is transmitted to a printer, the whole region of modified original image data coincides with the area where ink or a toner is applied in the printer, and therefore, the dimension and position of the print region of the modified original image data coincides with a printing medium set therein, resulting in that the image in the print region will be printed on the printing medium. Accordingly, a user need not care about the internal setting of a printer during the preparation of an original copy and the subsequent reading of the original image on the original copy into the image reading device, and he can obtain a printed matter on which the image of an expected size and/or an expected layout has been printed.

In this connection, it should be understood that, in the generation of a modified original image data, an original image data may be expanded or shrunk appropriately. When a printer is able to receive an image data of any dimension, an original image data may be expanded or shrunk arbitrarily, depending upon the data transmission speed, the image quality of a printed image, the size of a printing medium and a layout of an image on a printing medium or any other reasons. On the other hand, when a printer is able to receive only an image data of a specific or fixed dimension, the dimension of a pasteboard image data or a frame data may be set to a dimension of an image data receivable by the printer, and the size of the original image data may be reduced appropriately for obtaining a printed image having a size and a layout requested by a user. Some printers are not able to process a data having a dimension (the number of pixels) larger than a certain value due to the limitation of the capacity of memory and/or parameters for image processing in the printer. In such a case, an image data may be shrunk upon its transmission.

In operation, the inventive image reading device may be operated selectively in a normal mode or in a calibration mode. When the calibration mode is selected, a reference image data is outputted from the image data outputting portion, and an image data for modification is generated through the reading of the printed reference image by means of the image detecting portion. When the normal mode is selected, on the other hand, a modified original image data obtained by modifying an original image data by means of the image modification processing portion is outputted from the image data outputting portion. Further, preferably, when the calibration mode is selected, the image modification processing portion automatically computes modifying parameters required for generating a modified original image data from an original image data based upon an image data for modification and reference image data, and stores the resultant parameters in a memory. When the normal mode is selected, a modified original image data may be generated automatically from an original image data using the modifying parameters. Because of the automatic execution of the computation of modifying parameters and the generation of modified original image data using the modifying parameters, the duplicate and printing of an image become still easier for users.

Further, in the inventive image reading device, preferably, the size and layout of a printed image printed by a printer may be altered arbitrarily. As noted, upon duplicating or printing an original copy, drawn by handwriting or patching, for example, a New Year's card, a Christmas card, etc., with an image reading device, in most cases, a user expects that the image on the original copy is duplicated at the substantially same size. Thus, preferably, the image modification processing portion is designed to selectively generate a modified original image data such that a printed image will be printed at the substantially same size as an original image. However, since a printed image with margins or space around its periphery may be desired, an image modification processing portion may be designed to selectively generate a modified original image data such that margins will be provided in the periphery of a printed image on a printing medium. Moreover, on the contrary, in order to prevent a shadow of an edge of an original copy from appearing into a printed image or to avoid the generation of any marginal space due to misalignment in setting a printed medium on a printer, etc., a modified original image data may be generated such that the periphery of an original image will be cut off. In this connection, preferably, the image modification processing portion of the inventive device may be designed to allow a user to set up a margin width or a cut-off width on the printed image, when a margin is to be prepared in the periphery of a printed image or when the periphery of an original image is to be cut off. Further, a user may wish to print an image in so called “multiple attachment printing” mode, namely, a mode in which an original image is arranged and printed in multiple sites with a desired layout on one printing medium. Thus, the image modification processing portion may be designed to selectively generate a modified original image data so that an image corresponding to an original image will be printed with a layout desired by a user at multiple sites on a printing medium.

It should be understood that, in the present invention, through acquiring an image data for modification or the operation in the “calibration mode” as described above, the inventive image reading device is able to acquire information of an internal setting of a printer, namely, the information of a region actually printed on a printing medium within an image data transmitted from the image data outputting portion or a size on the printing medium of the image corresponding to the image data transmitted from the image data outputting portion. By using the acquired information of an internal setting of the printer, an image to be printed may be edited such that a printed image of an arbitrary size or of an arbitrary layout is to be generated on a printing medium in performing the duplication and printing of an image. Accordingly, if various layouts are ready to be selected for use, even the generation and children unfamiliar to a personal computer can enjoy various printing of images very easily by simply selecting a favorite layout from the layouts ready for use. Such layouts prepared previously will be designed appropriately by one of ordinary skill in the art, and it should be understood that layouts other than those described in this specification may be employed and such cases are considered to be included within the scope of the present invention.

Further, in the inventive image reading device, a printer setting portion which sets the dimension of a printing medium, or a printing resolution (the number of dots of ink, toner or other pigment per unit length) used in a printer may be provided, and thereby, a user is allowed to perform the printing of images with a desired image quality or a printing medium of a desired size. For example, the size of an original copy to be read with an image reading device may differ from the size of a printing medium.

It should be understood that the principle of the above-mentioned present invention may be used in an “image reading and a printing system”, namely, a system comprising an image reading device and a printer which is connected to this image reading device, receives image data, and prints an image corresponding to the image data to on a printing medium. The present invention may be employed in such a system for executing a calibration so as to print an image as expected from an original image.

Regarding the feature of the inventive image reading device, it should be noted firstly that any printer can be selected among those supporting a predetermined communication standard, currently available from various makers. As well known, the image quality of a printed image and a performance of a printer vary with manufacturers of printers and/or models of printers. However, according to the feature of the present invention, advantageously, a user can be choose an arbitrary printer (though within printers supporting a predetermined telecommunications standard which can be operative with the inventive image reading device), depending upon printer's prices or the user's liking. Moreover, a user who already has a printer need not to purchase another printer for duplication and printing of images with the image reading device.

Also, according to the inventive image reading device, because of the feature that an acquired original image is modified based on information of the internal setting of a printer before transmitted to the printer, a user need not consider the internal setting of the printer in the preparation of his own original copy, which also renders the above-mentioned feature of the ability to choose any printer more advantageous. As described above, in general, a printed size of an image on a printing medium and a region actually printed on a printing medium within an image data vary with models of printers, and therefore, an actually printed condition varies therewith. Thus, depending upon whether or not a printed condition is acceptable for a user, the range of selection of printers would be narrowed. According to the image modification processing portion in the inventive image reading device, however, since an image will be generated on a printing medium with the layout of an image on a original copy or a layout being set up in the image reading device, a user can choose a printer from more various models of printers without considering an internal setting of each of the printers with respect to the printed size of an image.

Further, an important advantage in the inventive image reading device is in that, since the printing of the original image can be done, irrespective of an internal setting of a printer connected to the image reading device, a user needs to care only about the range of the image reading region of an image reading device at the preparation of an original copy. As noted, the users trying to print or duplicate an image with an image reading device include the generation unfamiliar to PC and children which try to create a New Year's card, a Christmas card, etc. For such users, often not getting used to operate a PC and its peripherals, it is fairly troublesome to draw up an original copy while caring about an internal setting of a printer. According to the present invention, however, very conveniently, in order to obtain a printed image with the same size as the original image or of a desired size or a desired layout, a user needs only to create an original copy that the image reading device can be read.

Other objects and advantages of the present invention will be in part apparent and in part pointed out hereinafter.

### BRIEF DESCRIPTION OF DRAWINGS

FIG. 1 (A) is a perspective view of one preferable embodiment of the image reading device 1 of the present invention, and FIG. 1 (B) is a control block diagram of the structure in the image reading device 1.

FIG. 2 shows the flow of operations of a user, the inventive image reading device 1, and a printer 2; (A) in a calibration mode, and (B) in a normal mode.

FIG. 3 shows the flow of signal processing of the image reading device 1 in the form of the functional block diagram. The 1st and 2nd SWs are set to 2 in a calibration mode, and are set to 1 in a normal mode.

FIG. 4(A) is a reference image used for the first embodiment of computation of modifying parameters in the inventive image reading device 1, and FIG. 4(B) is an example of an image data for modification generated with the image reading device 1 by reading a printed image of the reference image of FIG. 4 (A) printed by the printer 2. In parentheses in the figures are coordinates on the image data (pixel position). The region surrounded with the dashed line in FIG. 4 (A) is a print region, which will be printed on a printing medium when the reference image is printed by the printer 2, as shown in FIG. 4 (B). In this connection, the size ratio between the whole reference image and the print region and the distance between the center of the reference image and that of the print region are exaggeratingly illustrated rather than an actual example for the purpose of explanation. FIG. 4 (C) shows the structure of the matrices M1-M4 used for detecting the position of vertices A-D of the rectangle region in the image data for modification. “1” and “0” within the frames show the brightness values of the respective pixels in a matrix.

FIG. 5 shows the flow chart of an exemplary algorithm for detecting the position of the vertex of the rectangle region in the image data for modification of FIG. 4(B) using the matrix M1 of FIG. 4 (C).

FIG. 6 (A) is a reference image used for the second embodiment of computation of modifying parameters in the inventive image reading device 1; FIG. 6 (B) is an example of an image data for modification generated with the image reading device 1 by reading a printed image of the reference image of FIG. 6 (A) printed by a printer 2. In parentheses in the figures are coordinates on the image data (pixel position). The region surrounded with the dashed line in FIG. 6 (A) is a print region, which will be printed on a printing medium when the reference image is printed by the printer 2, as shown in FIG. 6 (B). In this connection, the size ratio between the whole reference image and the print region and the distance between the center of the reference image and that of the print region are exaggeratingly illustrated rather than an actual example for the purpose of explanation. FIG. 6 (C) shows the brightness distribution near the points G and H of FIG. 6 (B), explaining a method for determining the points G and H. FIG. 6 (D) shows the structure of matrix M5 used for detecting the position of point o in the image data for modification of FIG. 6 (B). “1” and “0” within the frames show the brightness values of the respective pixels in the matrix.

FIG. 7 (A) is a reference image used for the third embodiment of computation of modifying parameters in the inventive image reading device 1, and FIG. 7 (B) shows the spatial relation between the reference image data and a printing medium upon printing the reference image of FIG. 7 (A) with the printer 2. The inside of the rectangle region, designated by “printing medium” is actually printed on the printing medium, read with the image reading device 1, and generated as an image data for modification.

FIG. 8 (A) shows the print sheet for printing the reference image used for the fourth embodiment of computation of modifying parameters in the inventive image reading device 1, and FIG. 8(B) shows that the reference image (the 1st embodiment) printed on the print sheet of FIG. 8(A). The dashed line in the rectangle region of FIG. 8 (B) shows the position of the rectangle region in reference image data, for comparison purpose. FIG. 8 (C) explains about how to compute inclination of the printed image in the image data for modification generated by reading the printed image of FIG. 8 (B) into the image reading device. FIG. 8 (D) shows a reference image used for the fifth embodiment of computation of modifying parameters in the inventive image reading device 1. In parentheses in the figures are coordinates on the image data (pixel position).

FIG. 9(A) is an example of a seal (sticker) paper used with the inventive image reading device 1. FIG. 9(B) shows the original image to be assigned to multiple sites in the paper of FIG. 9(A). FIG. 9(C) shows an image constituted by assigning multiple images of FIG. 9(B) to the multiple sites.

FIG. 10 shows a modified original image data generated in a just-fit printing mode of the inventive image reading device 1. FIG. 10 (A) shows a modified original image data prepared without dropping the resolution of original image data; FIG. 10(B) shows the modified original image data so prepared as to have the same dimension as the original image data.

FIG. 11(A) shows a modified original image data generated in a margin-less printing mode of the inventive image reading device 1; FIG. 11 (B) shows a modified original image data generated in a printing with margins mode of the inventive image reading device 1.

FIG. 12 shows a schematic diagram of one embodiment of an operation panel of the inventive image reading device 1.

FIG. 13 shows that the periphery of an image data transmitted to a printer has been cut off on a printing medium in a margin-less printing mode of the printer.

### DETAILED DESCRIPTION OF THE PREFERRED EMBODIMENTS

With reference to the attached drawings, the present invention will be explained in detail about some preferable embodiments.

### The Outline of an Image Reading Device

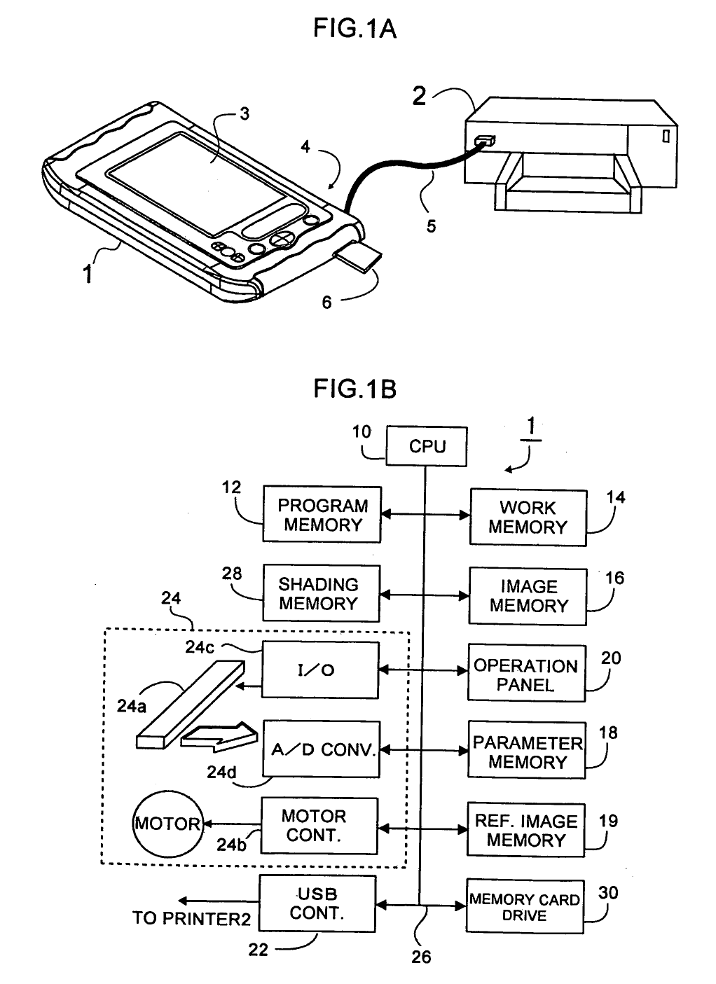

FIG. 1 (A) shows a perspective view of one preferable embodiment of the inventive image reading device 1. The image reading device 1 may be, so called, an “image scanner”, i.e., a device which, while scanning a paper sheet, a plastic sheet and other media, detects an original image drawn thereon optically (for example, by applying light on an object to be read to detect the reflected light from the object with a photon detection element or device, such as CCD), and converts the detected image information or signals into a digital data. The image reading device 1 may be of the type of a flat-bed scanner, in which an original image is positioned downwardly on a transparent board member, but, preferably, the image reading device 1 is a scanner of a type, as described in the reference publications described above, having a flat case whose top and bottom surfaces are formed with transparent board members (only the top surface 3 is shown in the drawing) and scanning an original copy positioned with an image to be read being directed upwardly under the bottom surface of the case (this type of scanners is advantageous because a user can check the original copy through the transparent top surface of the scanner.). On the top surface of the image reading device 1, there is provided also an operation panel 4 including buttons, etc., allowing a user to provide commands to the image reading device or to select its operation or printing mode. The image reading device 1 typically has a size allowing for reading an original copy of postcard size, but it may be adapted to allow for reading an original copy of the size of paper of B5 and A4 or others. In this connection, though not shown, the inventive device may be of a type of a “handy scanner” in which a reading device is manually moved on an original copy to read an original image thereon. Further, a device which the present invention is applied to may be a type of acquiring the whole image on an original copy at one time.

As shown in FIG. 1 (A), the image reading device 1 is directly connected to a printer 2 (typically, an ink-jet printer, but it may be of the other type) without interfaced with a PC. Printers 2 may be of any printer supporting a predetermined communication standard and, when receiving an image data, the printer 2 prints an image on a printing medium (not shown) in accordance with an internal own setting of the printer or a setting transmitted from the image reading device. The predetermined communication standard employed between the image reading device 1 and the printer 2 is typically “PictBridge” proposed for printing photographs with connecting a digital camera directly to a printer or a duplicator. However, the communication system or mode may be of the other type which enables communication between the image reading device 1 and the printer 2. Moreover, in the illustrated example, transmission and reception of signals between the image reading device 1 and the printer 2 are established with cable communication (USB etc.) through a cable 5, but a wireless data transmission with Bluetooth (registered trademark) or an infrared light may be used. Furthermore, the image reading device 1 may be provided with means to memorize image data to a memory card (SD card etc.) 6. For a printer 2 having the function of printing an image data memorized in the memory card, an image data may be transferred through a memory card.

The printer 2, directly connected to the inventive image reading device 1 and printing an image, is able to execute “margin-less printing” where an image is printed over the whole surface of a printing medium without leaving unfilled space in a periphery of the medium. In “margin-less printing” mode, the printer 2 prints an image represented by the received image data in a manner that the periphery of the image is printed out of, i.e. extends beyond, a printing medium.

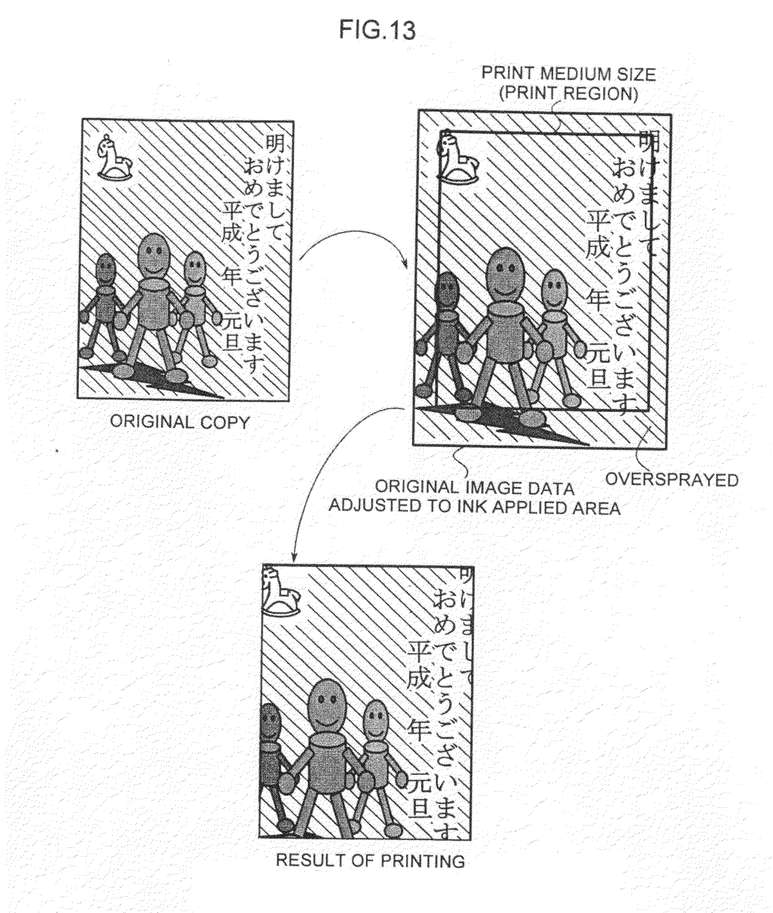

Referring to FIG. 13, for example, suppose that the image reading device 1 reads a region of postcard size, 148×100 mm, as shown in FIG. 13 upper left, at resolution of 300 DPI (the number of pixels per unit length) and generates the image data of vertical 1748 [vertical]×1181[horizontal] pix [i.e., the size of one pixel of the image data corresponds to 0.085 mm on the original copy.] to output to the printer 2 this image data of the dimension as it is. Then, if the printer 2 operates in “margin-less printing” mode to print the image represented by the received image data on a printing medium of postcard size at the resolution 300 DPI, i.e., the same resolution as in the reading in an image reading device, the image of the image data of 1748×1181 pix is set to be 1.03 to 1.05 times larger than a printing medium, in other words, the dimension of 1748×1181 pix is set to be magnified into 1800×1216 pix to 1835×1240 pix, resulting in that 3-5 mm of the periphery of the image represented by the received image data will extend beyond the printing medium (FIG. 13 upper right). Actually, in “margin-less printing”, since ink will be applied across the edge of the printing medium (overspray), the printing will be conducted without leaving unfilled space to the edge of the printing medium. Accordingly, the size of one pixel of the image data generated in the image reading device will be equivalent to 0.088-0.089 mm on a printing medium. That is, even if the resolution (the number of dots of the ink deposited per unit length) in the printing is at 300 DPI, the resolution of the image data transmitted from the image reading device would be changed to about 291 to 285 DPI on a printing medium.

In “margin-less printing” of a typical printer used for the inventive image reading device 1 as described above, irrespective of the dimension of a received image data, the periphery of an image extends beyond a printing medium at a certain determined width in each of the four directions of the medium. The width extending from the edge of a printing medium depends upon the size of the printing medium. For a sheet of postcard size, the extending width is normally about 3-5 mm. In other words, in “margin-less printing”, when the size of a printing medium is determined in a printer, the ink deposited region is so determined as to extend beyond the printing medium at a certain predetermined width, and the dimension of a received image data is adjusted such that the size of an image corresponding to the received image data will coincide with the ink deposited region. Thus, irrespective of the dimension of a transmitted image data, a dimension ratio and a position of a region actually appearing on a printing medium (a print region) in the transmitted image data are determined at the respective predetermined values in accordance with the internal setting of the printer, and a user cannot adjust the width of the periphery of the image extending from each edge of a printing medium and the size and position of a region within the image corresponding to the image data which actually appears on the printing medium. As a result, the printed image of the image data, read with the image reading device 1 and transmitted as it is thereform, is different in size from the original image, and/or, cut off at the periphery as shown in the lower of FIG. 13, not as expected by a user. Moreover, the region which actually appears on a printing medium within the images corresponding to an image data varies with models of printer or paper settings.

Therefore, as described in “Summary of the Invention”, the inventive image reading device 1 is designed to detect a region appearing on a printing medium within an image data received by the printer 2, the width and the direction of a periphery of an image data received by the printer 2 extending beyond the edge of a printing medium or the dimension or position of a predetermined pattern in a printed image of an image data received by the printer; and to modify an original image data, using the detected results, in order to print an image with a size or a layout desired pr requested by a user on a printing medium without the unintentional cutting off of the image periphery as seen in the lower of FIG. 13. In this regard, in the following explanation, the printer 2 is set to operate in margin-less printing mode, and a printing medium has the substantially same size as the whole region readable by one reading operation of the image reading device (the reading region of an image reading device). For instance, if a reading region of the image reading device is of postcard size, a paper sheet of postcard size is used for a printing medium. However, the principle of the present invention is applicable when the printer 2 operates in “printing with margins mode” (unfilled space is provided in the periphery of a printing medium) or other printing modes and when the size of a printing medium differs from the size of an original copy or the reading region of an image reading device, and it should be considered that such cases are included in the scope of the present invention.

### Structure of Image Reading Device

FIG. 1 (B) shows the structure in the image reading device 1 in the form of a control block diagram. Referring to the drawing, in the image reading device 1, CPU10, a program memory 12, a work memory 14, an image memory 16, an operation panel 20, a USB control portion 22 (image data outputting portion), and a scanner portion 24 are mutually connected with a bidirectional common bus 26 as in a known image reading device. CPU10 controls the operation of the image reading device 1 in the modes as explained in detail later, using the work memory 14 and other memories based on the system program memorized in the program memory 12.

The scanner portion 24 may be an image detecting device of a type well-known in the art, comprising an image sensor portion 24a (image detecting portion) which applies light on an original image to detect the reflected light therefrom, a motor and its control portion 24b which drive the image sensor portion to scan on an original copy. The light source and position of the image sensor portion 24a are controlled through an I/O portion 24c connected to the common bus 26 under control of CPU10, and, analog image information signals detected in the image sensor portion is digitized in an A/D conversion portion 24d (image data generating portion), and the digitized image data is stored in the image memory 16. In this regard, the image data read in the scanner portion 24 may be modified in known ways, such as a shading compensation, color modification, a gamma modification, and MTF modification, in order to compensate various characteristics of the image sensor. (Information for compensating characteristics of the image sensor may be stored in a shading memory 28, which information may be used at any appropriate timing.)

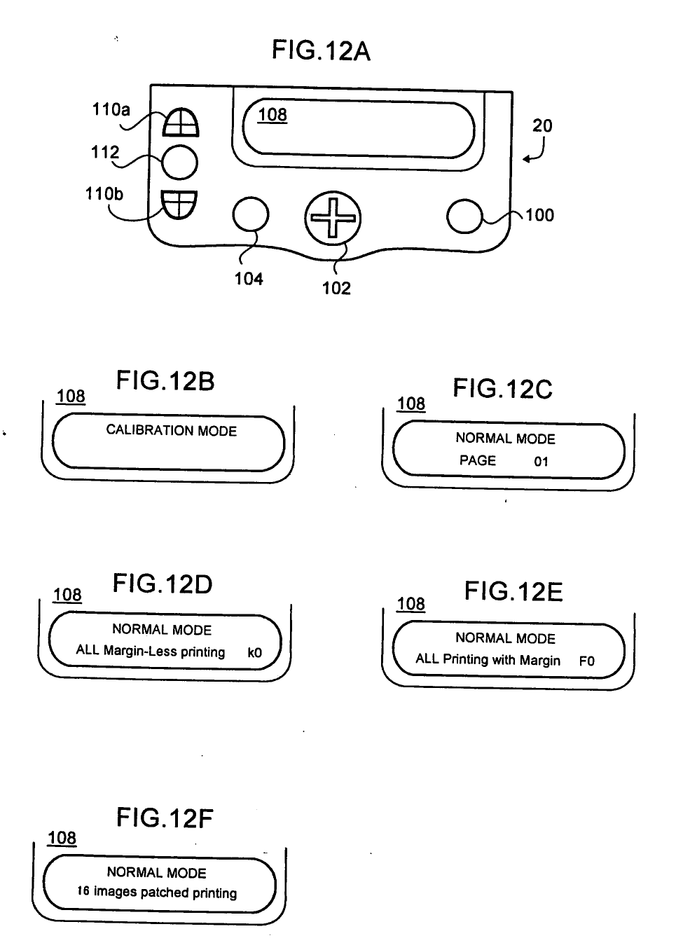

The operation panels 20 (reference numeral 4 in FIG. 1 (A)) is a panel, provided on the surface of an image reading device 1, including buttons for operation and a display, as illustrated to FIG. 12. In a manner explained in detail later, a user is allowed to give commands to the device 1 through the operation panel 20, and to confirm the operation modes of the device 1 and other settings.

As described above, the inventive image reading device 1, connected with the printer 2 supporting the predetermined communication standard, and transmits an image data directly to the printer 2, enabling the printer to print an image. For such operations, in the inventive image reading device 1, a printer control code is generated from an image data to be transmitted in a manner adapted for a predetermined communication standard under the control of CPU10. The printer control code will be further converted into a USB control code in the USB control portion 22 (image data outputting portion), and subsequently transmitted to the printer 2. In this regard, from the USB control portion 22 may be transmitted various control codes for printer's setting about dimensions and/or kinds of printing media or print papers, etc., and, if possible, codes for image quality or resolution of a printed image, in accordance with the predetermined communication standard. Further, if a radio or wireless telecommunication system is employed between the device 1 and the printer 2, the device is provided with a radio outputting portion (not shown). Also, if an image data is transferred using a memory card, the device 1 is provided with a memory card drive 30 (a memory card may store any image data generated in the device 1). Actual structures for transmitting various control codes and/or a drive for memory cards may be provided in a manner known in the art. Further, optionally, a means for transmitting an image to a PC (not shown) may be provided as in the conventional image reading device.

In addition, according to the inventive image reading device 1, as described in “Summary of Invention”, an original image data, which has been read and digitized in the scanner portion 24, is modified based upon an image data for modification so as to be printed with a size or a layout desired or requested by a user on a printing medium. The image data for modification is obtained by transmitting a reference image data from the image data outputting portion 22; printing a printed image of the reference image on a printing medium in the printer 2; and reading the printed image with the scanner portion 24. Thus, in the above-mentioned common bus 26, a parameter memory 18 is provided, memorizing the image data for modification, parameters, required in order to perform modification of original image data (modifying parameters), and/or other information about internal setting of a printer. Moreover, the common bus 26 may be connected with a reference image data memory 19, in which a reference image data representing a reference image is stored as usable appropriately under the control of CPU.

### The Outline of Operations of Image Reading Device 1

The inventive image reading device 1 operates alternatively in a calibration mode or a normal mode.

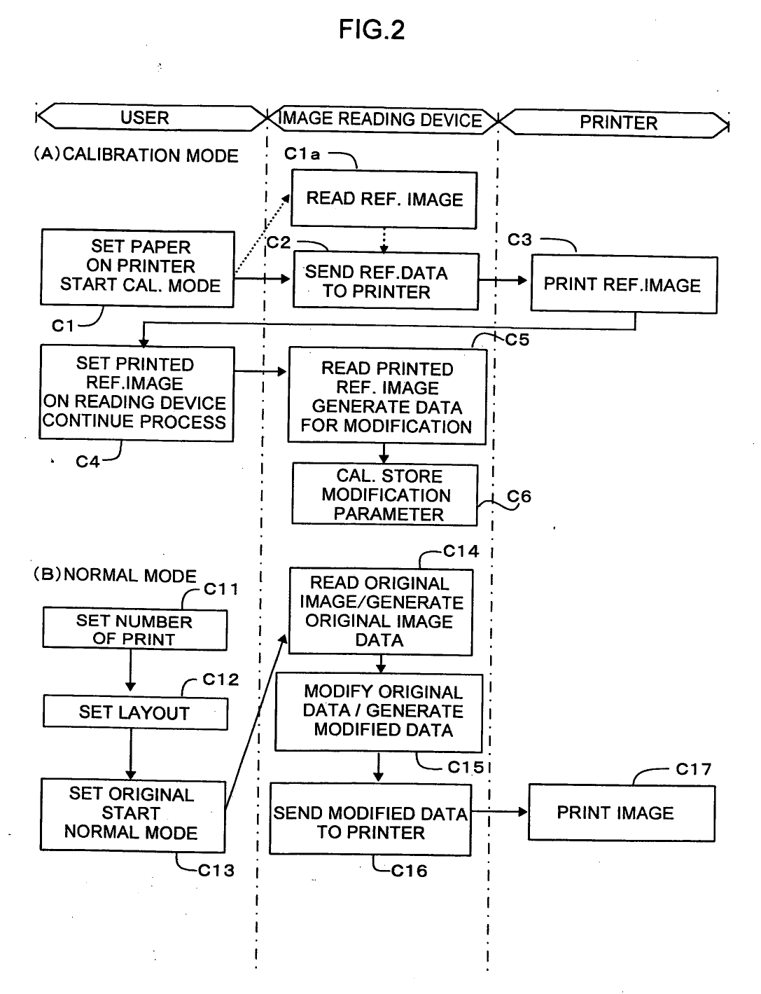

In the calibration mode, briefly, internal setting information on a printer (information about how the image data received by the printer is printed on a printing medium) is obtained by reading and analyzing a printed image of a reference image printed by the printer 2, and memorized in an image reading device 1. The operations of a user, the image reading device 1 and the printer 2 in this mode are as follows: Referring to FIG. 2 (A), when the start of operation in the calibration mode is requested by the user through the operation panel 20 (C1), a reference image data is transmitted to the printer 2 from the image reading device 1 (C2), and the printing of a reference image is conducted (C3). In this regard, the reference image data is an image data representing an image of a predetermined dimension (pixel number) including a predetermined pattern. Then, when the printing of the reference image is completed, a user sets the printed image of the reference image to the image reading device 1 (C4), and provides a command of continuation of processing through the operation panel. In response to the user's command, the image reading device 1 starts reading the printed image of the reference image, and generates an image data for modification (C5). Then, through either one of the techniques explained in detail later, the internal setting information or modifying parameters used for the printer are computed from the image data for modification (C6), and the resultant information or parameters are stored in the parameter memory 18. In this regard, instead of the storing of the reference image data in the memory 19, the reference image data may be generated at the staring of the calibration mode, by reading a reference image drawn on a paper sheet, or other medium. In that case, the operation of Cla will be required.

In the normal mode, briefly, an image data of an original copy read in the scanner portion 24 is modified using the internal setting information or modifying parameters of the printer acquired in the calibration mode, and thereby, the original image is printed with a size or a layout desired or requested by a user on a printing medium. The operations of a user, the image reading device 1 and the printer 2 in this mode are as follows: Referring to FIG. 2 (B), first, the user sets an original copy in an image reading device 1, and requests the start of operation in the normal mode through the operation panel 20 (C13). Before this operation, the setting of the number of the printing (C11) and the selection of a layout of the image on a printing medium (C12) may be conducted by the user. In this regard, as a default setting, the printing number may be set to one, and “just-fit printing mode”, in which the whole original image is printed in conformity with the whole area of a printing medium, may be set for the layout setting. Then, in response to the command of the operation start of the normal mode, the image reading device 1 reads an original image, and generates an original image data (C14). At this time, the arrangement of the original image data may be performed in order to generate an image data with a layout selected in C12 (In the following, an image data obtained by arranging an original image data in accordance with a certain layout is referred to as “arranged image data”.). Next, in order to print the original image on the printing medium with the selected layout, the original image data or arranged image data is modified, by means of modifying parameters, to generate a modified original image data (C15), and the resultant modified image data is transmitted to the printer 2 (C16). The printer 2, when receiving the modified original image data, will print an image according to an internal setting of the printer (C17).

As described in detail later, the modified original image data to be transmitted to the printer 2 is prepared such that the image data which should appear on a printing medium is assigned in a print region of the modified original image data, i.e., under condition that the modified original image data is adjusted in the printer 2 to be larger in size than a printing medium, the original image data or arranged image data with the selected size or the selected layout appears on a printing medium. Thus, when the printer 2 adjusts the dimension of the whole modified original image data so as to extend beyond the edge of the printing medium before the printing of modified original image data, the print region in the modified original image data coincides with the whole printing medium, and thereby avoiding unintentional cutting off of the periphery portions of the original image data or arranged image data and the printing of an image with size unexpected by the user.

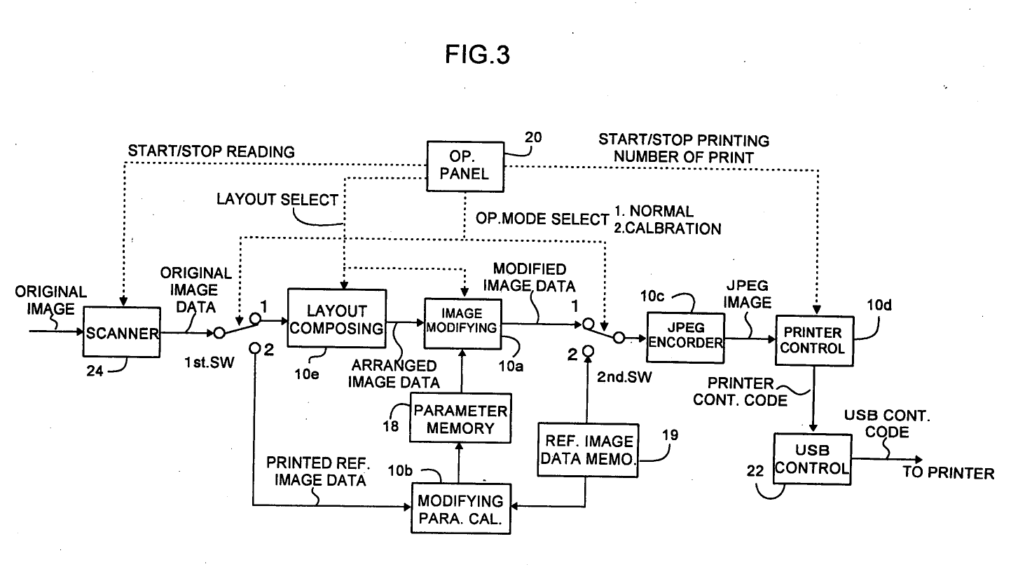

FIG. 3 shows the flow of signal processing in the calibration mode and normal mode in an image reading device 1 with the form of a functional block diagram. “Image modification portion 10a”, “Modification parameter computation portion 10b”, “JPEG encoder 10c”, “Printer control portions 10d”, and “Layout composing portions 10e”, as explained below, are realized by the operation of CPU 10.

Referring to this drawing, when the calibration mode is selected through the operation panel 20, (In the drawing, the first and the second switches are set to “2”.) and the execution start of processing is requested, a reference image data is outputted from the reference image data memory 19 to the JPEG encoder 10c, in which the reference image data is encoded in JPEG form. The reference image data of JPEG form is outputted to printer control portion 10d from the JPEG encoder 10c, and is converted to a printer control code, which is transmitted to the printer 2 in the form of a USB control code from the USB control portion 22. In this regard, instead of storing the reference image data in the reference image data memory 19, the reference image data may be acquired by reading a copy on which the reference image is drawn with the scanner portion 24, and subsequently, outputted to the JPEG encoder 10c. Further, although, here, JPEG form is employed for the image format, the other image formats, such as GIF form, BMP form, or RAW form, may be employed if the printer supports them.

After the reference image is printed and the printed image is set to the scanner portion 24 of the image reading device 1 by the user, when the user provides a command of continuation of processing, the scanner portion 24 reads the printed image of the reference image, and then, an image data for modification is generated and sent to the modification parameter computation portion 10b. The modification parameter computation portion 10b analyzes the image data for modification and computes modifying parameters as explained in detail later. Then, the resultant parameters are stored in the parameter memory 18, and the calibration mode is completed.

When the normal mode is selected (the first and the second switch is set to “1”.) and the execution start of processing is requested, the scanning of an original copy to read an original image are conducted with the scanner portion 24, and the original image data obtained in that way is transmitted to the layout composing portion (or arranged image generating portion) 10e. As explained in detail later, in the layout composing portion 10e, in order to arrange images on a printing medium with an arbitrary layout, “editing” or “arranging” of the original image data is executed. In a case that an original image is always printed substantially as it is, the layout composing portion 10e may be omitted. With respect to such a layout of an image on a printing medium, since it is difficult in the inventive image reading device to edit an image freely as in a PC, it is preferable that some layouts are prepared previously and a user can select the favorite layout therefrom through the operation panel 20.

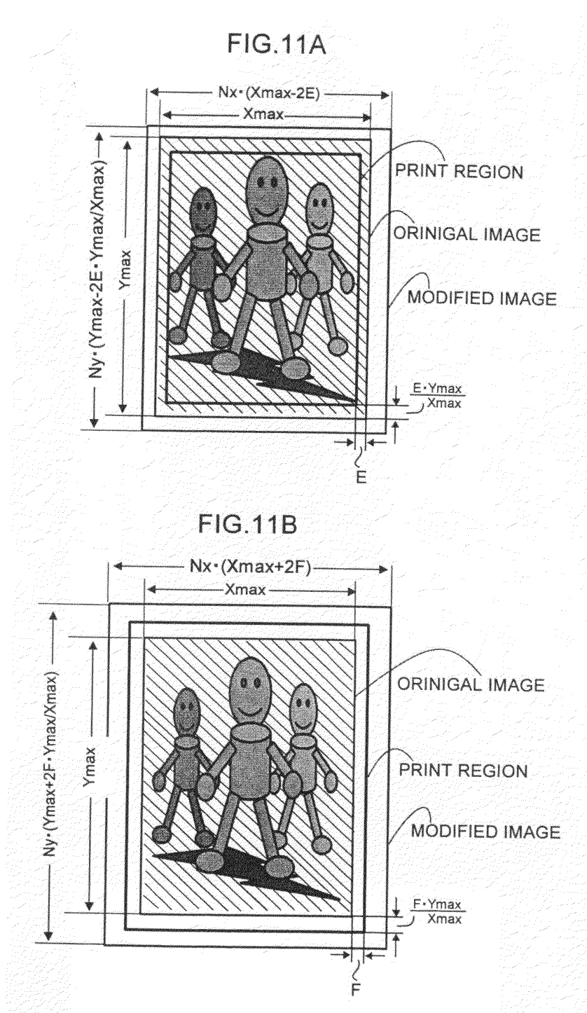

Then, the original image data or arranged image data, which have passed through the layout composing portion 10e, is modified in the image modification portion 10a, using the modifying parameters stored in the parameter memory 18, in one of manners explained in detail later, as illustrated in FIGS. 10 and 11, in order to print an image represented by the original image data or arranged image data on a printing medium. And, when the image data so modified (modified original image data) is transmitted to the printer 2 through the JPEG encoder 10c, printer control portion 10d and USB control portion, the printing of the image is performed.

In both the calibration mode and normal mode, when the printing operation is not available in the printer 2, such as power-off, out of paper, out of ink, etc., its condition may be informed of with a warning lamp etc. Moreover, signals indicating commands from the user of discontinuation, a stop and resumption of processing, printing number of sheets, etc. may be transmitted through the operation panel 20 to the scanner portion, the printer control portion or the other processing portions. Furthermore, when no modifying parameters is prepared upon turning on the image reading device 1 or on staring an operation in the normal mode, the device 1 may warn a user of the absence of modifying parameters or automatically select the calibration mode.

In the following, “computation of modifying parameters”, “layout composing” and “generation of modified original image data” and “Operating an operation panel”, as outlined in the above, are explained in more details.

### Computation of Modifying Parameters

In Calibration mode, as noted, in “modification parameter computation portion 10b”, comparing a reference image containing a predetermined pattern, represented by an reference image data outputted from the image reading device 1, with the printed image (image data for modification) printed on a printing medium by the printer 2 which receives the reference image data representing the reference image, there are detected a size on the printing medium of the image corresponding to the image data transmitted to the printer 2, or, a size and a position of a region (print region) which actually appears on the printing medium within the image data transmitted to the printer 2. Then, based upon the results of the comparison and detection, modifying parameters used in the normal mode are computed. Hereafter, preferable embodiments of computing modifying parameters from the comparison analysis of a reference image data and an image data for modification will be explained about.

### (i) The First Embodiment of Commutation of Modifying Parameters

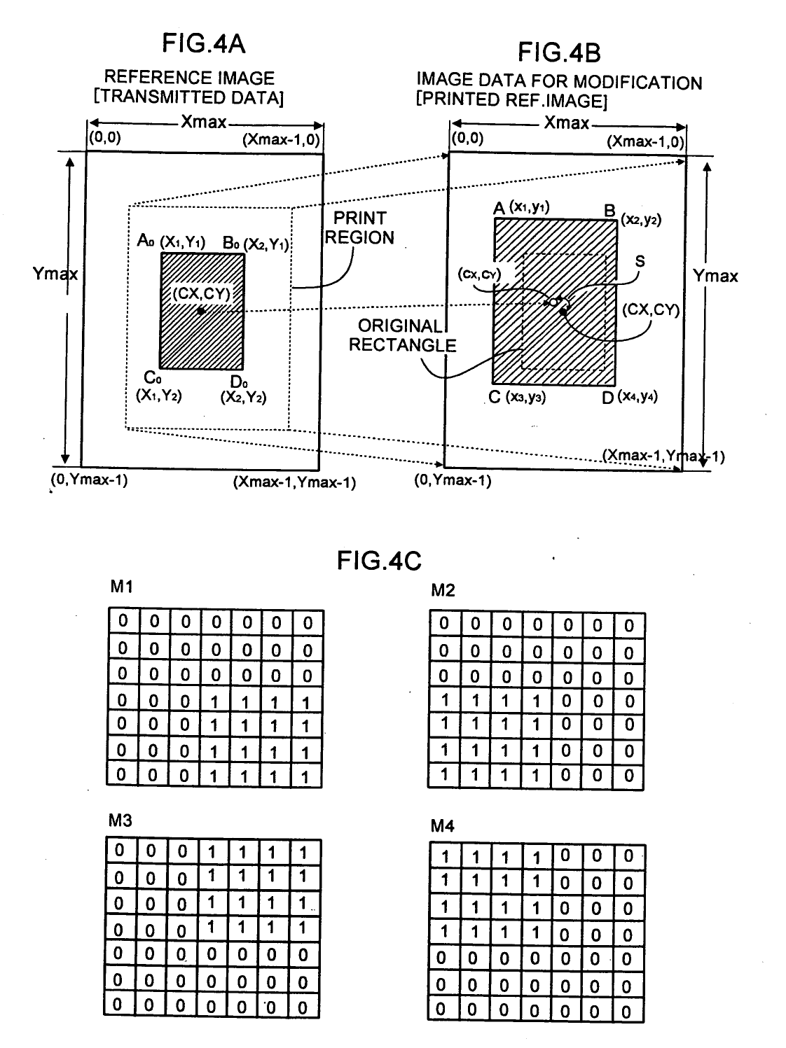

In the first embodiment of computation of modifying parameters, an image as shown in FIG. 4 (A) is outputted to the printer 2 as a reference image, and the printed image of the reference image is acquired as an image data for modification.

The reference image of FIG. 4 (A) of a dimension, Xmax×Ymax, has a rectangular region A₀B₀D₀C₀ as a predetermined pattern in the center thereof. The interior and exterior of the rectangle each have uniform brightness, and, most simply, the interior of the rectangle may have an arbitrary brightness since a printing medium is usually white (at brightness value of 255). Because the printer 2 is usually a color printer, the brightness of the interior of the rectangular region may be set to (R, G, B)=(0, Δ 0) [Δ may be set to an arbitrary value.] and the exterior thereof may be set to (R, G, B)=(255,255,255) in a RGB system, but not limited to these. Further, preferably, the center of the whole region of the reference image data and the center of the rectangular region coincide with each other, and the respective edges of the rectangle region extend along X or Y direction of the image data. However, for the purpose of the present invention, other patterns may be employed. The dimension of the reference image data is preferably the same as the dimension of the image data generated through the reading of the reading region of the image reading device 1, but it should be understood that the former may differ from the later.

When the reference image data of FIG. 4 (A) is transmitted to the printer 2, the printing image (FIG. 4 (B)) of the reference image will be generated on a printing medium. Then, the image data for modification is prepared by reading the printed image of the reference image printed on the printing medium with the image reading device 1. As noted, since the printer 2 prints an image such that an image represented by the received image data will extend beyond the edge of a printing medium, the interior of the print region indicated by the dotted line in FIG. 4 (A) will be printed on the printing medium. In the present embodiment, the reference image data has the same dimension Xmax×Ymax as an image data generated by reading an image with the image reading device, and also, the reading region of the image reading device have the same size as the printing medium, so that the dimension of the rectangular region ABDC of the image data for modification will be expanded relative to the rectangular region A₀B₀D₀C₀ of the reference image data.

The size of the region actually printed on the printing medium within the image data transmitted to the printer 2 (the size of the print region of the image data) or the size of the image represented by the image data transmitted to the printer 2 on the printing medium can be determined from the ratio (scaling factor N) of the dimension of the rectangular region in the image data for modification (FIG. 4 (B)) to that of the rectangular region in reference image data (FIG. 4 (A)). Moreover, since the center of the rectangular region in the reference image is made coincide with the center of the whole reference image, the width and direction of the periphery portion being cut off in the image (extending beyond the printing medium) in the printing with a printer 2, or, the position of the actually printed region in the image data can be specified through detecting the distance (shifting amount S) of the center position of the rectangular region in the image data for modification from the center position of the image data for modification. In this regard, when a reading region of the image reading device and a printing medium have the same size, and a reference image data and an image data generated through the reading of an image in the reading region of the image reading device have the same dimension, the scaling factor N is the inverse of the ratio of the dimension of a print region of an image data transmitted to the printer 2 to the dimension of the image data, and the scaling factor N also corresponds to the size ratio of a printed image (when printed without modification) to an original image.

[When the dimension of a reference image data differs from the dimension of an image data generated through the reading with the image reading device, the scaling factor N is given by the following expression:

ti N=(k×Z)/(n×X),
where k is the reading resolution (pix/mm) of the image reading device; Z is the absolute size (mm) of a printing medium, X is the dimension (pix) of a reference image data, n is the ratio of the dimension of a print region of an image data transmitted to the printer 2 to the whole dimension of the transmitted image data. In this embodiment, (k×Z)/X×=1.]

The scaling factor N and shifting amount S may be computed as follows: Referring to FIG. 4 (A), suppose that the coordinates of the vertexes of the rectangular region of the reference image data are set to A₀ (X₁, Y₁), B₀ (X₂, Y₁), C₀ (X₁, Y₂), and D₀ (X₂, Y₂), respectively, and the coordinates of the vertices of the rectangular region of the image data for modification are set to A (x₁, y₁), B (x₂, y₂), C (x₃, y₃), and D (x₄, y₄). When the aspect ratios of the image data for modification does not change from that of the reference image data, namely, when the printer 2 prints an image data without changing the aspect ratio thereof, from the ratio of the lengths of the diagonal lines of the rectangular regions in the two images, Scaling factor N is given by:

$$\begin{matrix}N = B C / {B}_{0} {C}_{0} \\ = {\{ {( {x}_{2} - {x}_{3} )}^{2} + {( {y}_{2} - {y}_{3} )}^{2} \}}^{1 / 2} / {\{ {( {X}_{2} - {X}_{1} )}^{2} + {( {Y}_{1} - {Y}_{2} )}^{2} \}}^{1 / 2} ,\end{matrix} \qquad ( 1 )$$

where BC and B₀C₀ are the length of the diagonal line between the vertices. For the length of the diagonal line of the rectangular region of the image data for modification, the average of two diagonal lines may be used.

When there is a possibility that the printer 2 changes the aspect ratio of an image, the scaling factors N_{X}, N_{Y} for the X and Y directions, respectively, are detected from the ratios of the lengths of the edges of the rectangular region for the respective X and Y directions, as follows:

Scaling factor for X direction N_{X}=AB/A₀B₀ or CD/A₀B₀ (2)

Scaling factor for Y direction N_{Y}=AC/A₀C₀ or BD/A₀C₀ (3)

In the computation of the respective scaling factors, the lengths of the edges of the rectangular region of image data for modification may be the averages for the two edges in the respective X and Y directions.

The respective center positions of the rectangular regions of reference image data and the image data for modification are given by: For the reference image data (C_{X}, C_{Y})

C_{X}=(X₁+X₂)/2; C_{Y}=(Y₁+Y₂)/2 (4)

For the image data for modification (cₓ, c_{y})

cₓ=(x₁+x₂+x₃+x₄)/4; c_{y}=(y₁+y₂+y₃+y₄)/4 (5).

Thus, shifting amounts Sₓ and S_{y} of the center positions of the rectangular region of the image data for modification (the distance of the center of the printing medium from the center of the printed reference image) are given by:

Sₓ=C_{X}−cₓ; Sy=C_{Y}−c_{y} (6).

Then, based upon the scaling factors N_{X}, N_{Y} and Shifting amount Sₓ and S_{y} the print region, appearing on the printing medium, in the image data of the dimension, Xmax×Ymax, transmitted to the printer 2 will be specified with the range in the coordinate system of an image data transmitted from the image reading device (namely, the coordinate system of the reference image) as follows: for X direction,

from (Xmax−Xmax/N_{X})/2+Sₓ/N_{X} to (Xmax+Xmax/N_{X})/2+Sₓ/N_{X} (7a);

for Y direction,

from (Ymax−Ymax/N_{Y})/2+S_{y}/N_{Y} to (Ymax+Ymax/N_{Y})/2+S_{y}/N_{Y} (7b)

(Region in the rectangle indicated with the dashed line in FIG. 4 (A)) The values of the scaling factor N (or N_{X}, N_{Y}) and shifting amount Sx and Sy, or the coordinate values of the range of the print region are stored in the parameter memory as modifying parameters and used in the normal mode, for modification of an original image data or an arranged image data so as to print images represented by those image data without extending beyond the printing medium.

The coordinates of the vertices ABCD of the rectangular region of the image data for modification can be determined by making the image data for modification in the binary form with an appropriate threshold value Th (The brightness values of the inside and outside of the rectangular region are set to 1 and 0, respectively.), and subsequently by calculating a correlation of the brightness distributions between a neighborhood of each vertex of the rectangular region of the image data for modification and matrices (or kernels) M1·M4 of brightness values having 7×7 pixels as shown in FIG. 4 (C). The correlation is given by:

Cr=Σ NOT (Mk(i,j)EXOR P(x+i,y+j)) (8).

where Mk (i, j) is a brightness value of a pixel at a coordinates (i, j) of Matrix Mk (k=1, 2, 3, 4) [−3≦i≦3, −3≦j≦3, i and j indicate crosswise and lengthwise directions, respectively. The coordinate of the center of a matrix is (0, 0)]; P (x+i, y+j) is a brightness value of a pixel at the coordinate (x+i, y+j) in image data for modification; and NOT and EXOR are NOT operation and exclusive OR operation, respectively, and Σ is summation about i and j. The correlation Cr is obtained by calculating the value of exclusive OR of the brightness of matrix Mk and the brightness P of the image data for modification for every coordinate while the center (0, 0) of a Matrix Mk is superposed on a coordinates (x, y) of the image data for modification (because of NOT operation, the resultant value is 1 when the brightness values of superposed pixels coincide with each other.), and by integrating the resultant exclusive OR values for the whole coordinates in the range of −3≦i, j≦3. Thus, the correlation Cr increases as patterns (brightness distribution) of two superimposed regions, namely, Matrix Mk and a region in image data for modification are geometrically closer to each other. As seen from the drawing, the respective Matrices M1-M4 have a brightness pattern corresponding to the brightness distribution near the vertexes of the rectangular region, where the brightness value of 4×4 pixels is “1” in the corner of the right lower, left lower, right upper and left lower, respectively, and the rest of the pixels are assigned with “0”. So, when the correlations between Matrix Mk and the image data for modification at least in the neighborhood region of the vertex of the rectangular region are computed while shifting the center position of Matrix Mk on the image data for modification, the position (x, y) of each of the Matrix M1-M4 on the image data for modification which gives the maximum of the correlation will be determined as coordinates of the position of each vertex of A, B, C, and D of a rectangular region. (Here, the above-mentioned detection technique is called a “pattern extraction filtering” method.)

For each vertex of the rectangular region, the range for computation of the correlation Cr may be appropriately set up, considering the difference between the position of the vertex in the reference image and the position of its printed image due to the size expansion at the scaling factor from an original image to its printed image, misalignment of a printing sheet fed on the printer 2 upon the printing operation, an error in the size of a postcard and an error of the set position of an original copy on the scanner portion 24 by a user, etc. For instance, since it is expected that the vertex A of the rectangular region on the image data for modification will exist near the vertex A₀ (X₁, Y₁) of the reference image data, the range in which Correlation Cr is computed may be set as:

X1−δ≦x≦X1+δ

Y1−δ≦y≦Y1+δ,

where δ may be set by expecting the displacement of the vertex in the printed image: for instance, if the estimated maximum displacement is 5 mm, equivalent to about 59 pixels in 300 DPI, it may be set that δ=59.

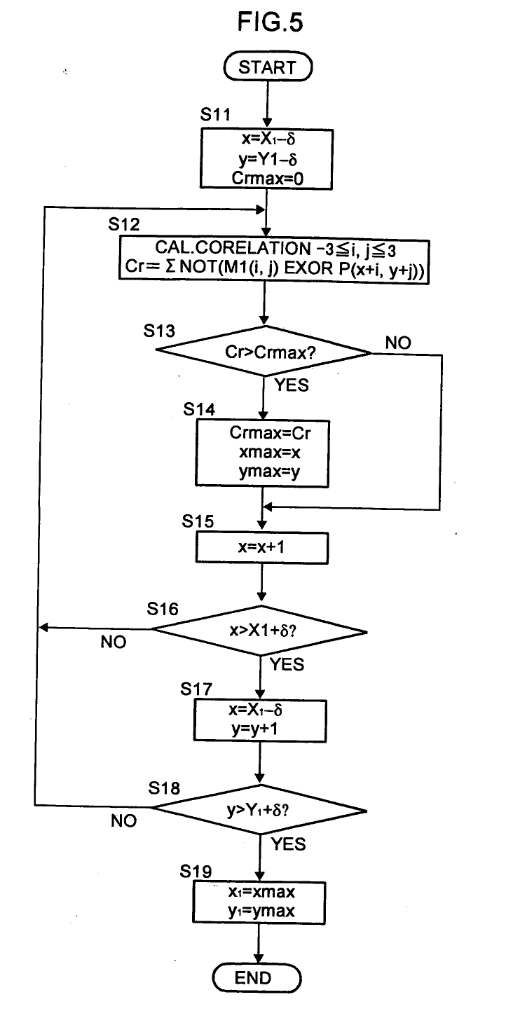

The determination of the coordinates of the vertices by means of the correlation Cr may be conducted through an exemplary computation process as described in the form of the flow chart in FIG. 5. In this regard, although, as an example, only the process of specifying the position of the vertex A is explained using M1, it should be understood easily for one skilled in the art that the positions of the vertices B, C, and D can be specified similarly.

Referring to FIG. 5, first, as an initial value of the computation process of Correlation Cr using M1, x=X1−δ, y=Y1−δ, Crmax=0 (Crmax is the maximum of Cr) are set up (Step S11). And, the correlation Cr in (x, y) is computed in −3≦i, j≦3 (Step S12). When Cr is larger than Crmax, (Step S13), Cr is memorized as Crmax, and (x, y) at that time are memorized as (xmax, ymax) (Step S14). Then, the value of x is increased (Step S15), and Step S12-S15 are repeated until x>X1+δ is established (Step S16). When x>X1+δ is established, the value of y increases and x is returned to the initial value, X1−δ (Step S17), and, again, step S12-S15 are repeated until x>X1+δ is established (Step S16). During repeating the processes of step S12-S17 until y>Y1+δ is established (Step S18) while increasing the value of y whenever x>X1+δ is established, Crmax and (xmax, ymax) are updated whenever a newly computed Cr becomes larger than Crmax memorized till then, and finally, when y>Y1+δ is established (Step S18), the maximum correlation value Cr in the region in which the correlation are calculated will be memorized as Crmax. As noted, since the pattern of the image data for modification is geometrically matched with the pattern of M1 at the highest degree when the correlation value Cr is the maximum, the center position, xmax and ymax, of M1 in the end of the processes will be determined as the coordinate of the vertex A (Step S19).

In the above-mentioned process, the dimension of a matrix may be set arbitrarily in order to avoid an influence of noise on reading the printed image of the reference image in the scanner portion 24.

By the way, for instance, the scaling factor N is computable by converting the values of the inside and outside of the rectangular regions of the reference image data and image data for modification into (1, 0) in the binary data and calculating the square root of the ratio between the integration of the brightness values of the whole image data for modification (ΣP(x, y):Σ is the summation for x and y) and the integration of the brightness values of the whole reference image data (τP₀(x, y):Σ is the summation for x and y), because the integrated value of the brightness in the whole image data is proportional to the area of the rectangular region when the brightness of the exterior of the rectangular region is 0. Further, the shifting amount Sx and Sy is obtained by computing the distance of the center of gravity of the brightness in the whole image data for modification from the center of gravity of the brightness in the whole reference image data, because the center of gravity of the brightness in the whole image data is the center of the rectangular region when the brightness of the exterior of the rectangular region is 0.

### (ii) The Second Embodiment of Computation of Modifying Parameters

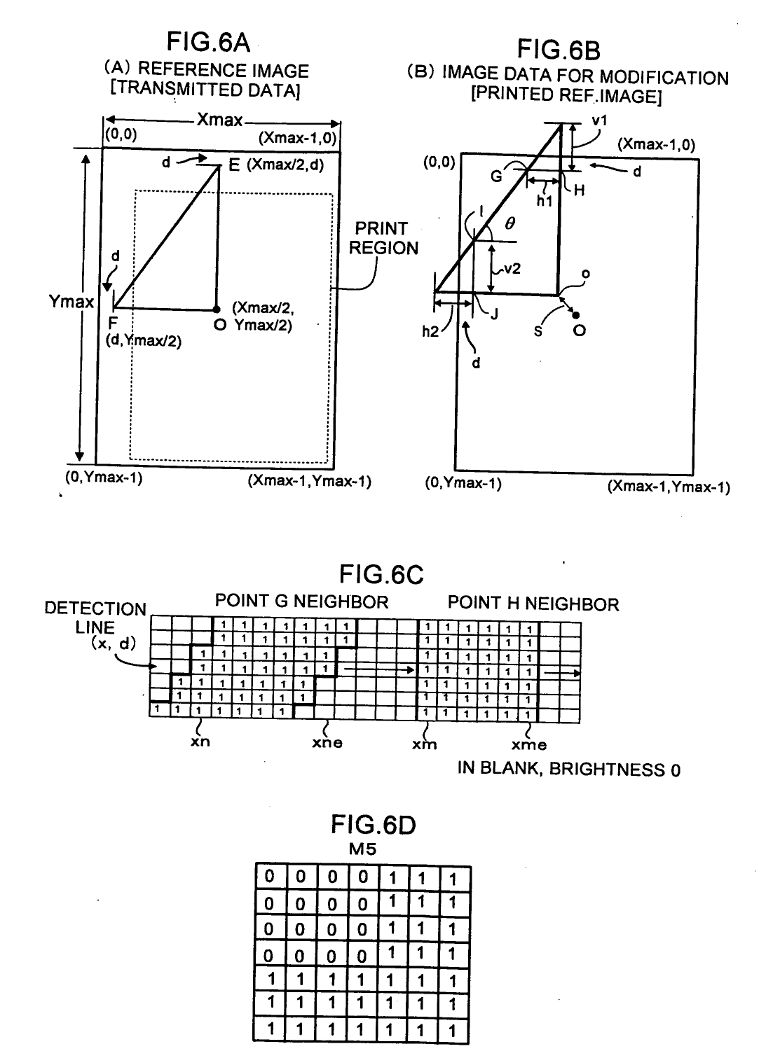

In another embodiment of computation of modifying parameters, a reference image, as shown in FIG. 6 (A), including a pattern of a right angled triangle may be employed. In this figure, the right-angled vertex O of the right angled triangle coincides with the center (Xmax/2, Ymax/2) of the reference image, and the vertices E and F each are located at the points of (Xmax/2, d) and (Ymax/2, d), respectively, distanced by d from the upper side and the left side of the reference image. The widths of the edge lines of the right angled triangle may be about 6 pixels, for example.

When the reference image of FIG. 6 (A) is passed through the printer 2, only the rectangular region surrounded by the dotted line in this figure will appear on a printing medium. Thus, as in FIG. 6(B), the vertices E and F may be cut away in the printed image. However, in the image data for modification obtained by acquiring the printed image of FIG. 6 (B) into the image reading device 1, when the points G (xg, d), H (xh, d), I (d, yi), and J (d, yj) separated by d from the upper and left side of the reference image and the printed image o (xo, yo) of the right-angled peak O in the printing image are located, it is enabled to determine the dimension of the whole triangle and its position on the printing medium based upon geometric characters of a right angled triangle. Accordingly, based on the dimension and position of the right angled triangle on the printing medium, the scaling factor N and shifting amount S, or the width and the direction of the cut-off periphery portions will be estimated.

Referring to FIG. 6 (B), the scaling factor N_{Y} in the Y direction is given by:

N_{Y}=(oH+v1)/OE,

so that, using the relation of v1=HG−tan θ=h1−tan θ, the scaling factor N_{Y} is expressed by:

N_{Y}=(yo−d+h1·tan θ)/(Ymax/2−d) (9a)

where h1=xh−xg and tan θ=(yi−d)/(xg−d).

On the other hand, using h2=IJ/tan θ=v2/tan θ, the scaling factor N_{X} in the X direction is given by:

$$\begin{matrix}{N}_{X} = ( oJ + h 2 ) / OF \\ = xo - d + 2 / tan θ \text{/} ( X max / 2 - d )\end{matrix} \qquad ( 9 b )$$

where v2=yj−yi.
Shifting amount S is given by:

Sx=Xmax/2−xo; Sy=Ymax/2−yo (10).

As in the first embodiment, these values are stored in the parameter memory as modifying parameters in order to use them for modification of an original image data or an arranged image data in the normal mode. In this connection, as understood by one skilled in the art, although the above embodiment employs, for a predetermined pattern, a right angled triangle whose the right-angled vertex is positioned on the center of an image, such a predetermined pattern may be an arbitrary pattern of which geometric characters enable to determine the position and dimension of a portion having been cut off on an image data for modification, and it should be noted that such a case is included in the scope of the present invention.

In computation of the above-mentioned parameters, the image data for modification is converted into the binary form while setting the brightness values of the image of the triangular edges and the background to “1, 0”, respectively. For example, the points G (xg, d) and H (xh, d) are determined by detecting the position and width of the pixel sequence of the brightness of 1 in the line (x, d): 0≦x≦ of Xmax−1, of the image data for modification, and specifying the center of the pixel sequence as the point G or H. As shown in FIG. 6 (C), when the brightness values are “1” from (xn,d) to (xne,d) and from (xm,d) to (xme,d) in a line (x, d), xg and xh each are specified as xg=(xne+xn)/2; xh=(xme+xm)/2. For the detection of a pixel sequence of brightness value “1”, for example, the brightness value of the pixels is inspected sequentially along the line (x, d) of the image data for modification: when four or more pixels of brightness value “1” are detected continuously, those pixels are judged as a pixel sequence of brightness value “1” (In this method, the sequence of the brightness value “1” of less than 4 pix will be excluded as noise.). Similarly, points I (d, yi) and J (d, yj) is determined by detecting the position and width of a pixel sequence of a brightness value “1” in the line (d, y) of image data for modification (0≦y≦Ymax−1), and specifying the center of the pixel sequence as the point I or point J (not shown). The printing image o(xo, yo) of the vertex O may be determined by calculating correlation Cr near the printed image o with the matrix M5 as shown in FIG. 6 (D) as described in the flow chart of FIG. 5.

(iii) The Third Embodiment of Computation of Modifying Parameters

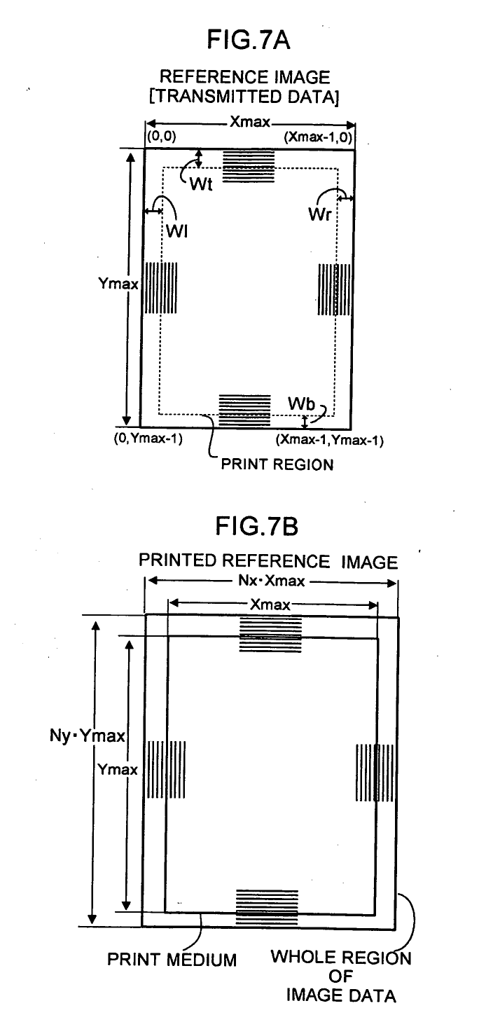

In another embodiment of computation of modifying parameters, as shown in FIG. 7 (A), a reference image in which several line segments (for example, 9) are drawn at a predetermined interval in the upper, lower, left side and right side periphery portion may be employed. When this reference image is passed through the printer 2, the whole region of the reference image data is adjusted to extend beyond a printing medium as shown in FIG. 7 (B), and thus, only the interior region of the frame indicated as a “printing medium” in the drawing will be printed while several line segments of the upper, lower, left side and right side periphery portions are cut away. In the reference image, the coordinates or the pixel of the line segments are known so that, by counting the number of the line segments in the printed image, the width or the number of pixels in each of the periphery portions to be cut off in the reference image can be estimated.

The counting of the number of the line segments on the image data for modification may be executed, for example, by converting the image data for modification in the binary form with the brightness values of the images of the line segments and the background being set to “1, 0”; by inspecting sequentially the brightness value of a pixel in the direction perpendicular to a line segment sequence in a region in which the line segment sequence is expected to be positioned while counting the number of times of changing of brightness value from “0” to “1” or from “1” to “0”. In this process, in order to eliminate any influence of noise, only the cases where the brightness value does not change in a predetermined length before and after changes of the brightness value may be counted as the brightness changing.

Then, when the widths Wt, Wb, Wl, and Wr (the unit is the number of pixels) to be cut off in each of the upper, lower, left side and right side periphery portions in the reference image are specified, the region printed on the printing medium (the rectangular region surrounded by the dotted line of FIG. 7 (A)) is detected as from Wl to Xmax−Wr−1 for X direction and from Wt to Ymax−Wb−1 for Y direction, and the scaling factors are given by:

N_{X}=Xmax/(Xmax−Wl−Wr) (11a)

N_{Y}=Ymax/(Ymax−Wt−Wb) (11b)

Further, Shifting amount Sx and Sy may also be computed using Wt, Wb, Wl, and Wr. (Shifting amount Sx and Sy is given by Sx=Nxx(Wl−Wr)/2; Sy=Nyx (Wt−Wb)/2.). The resultant computed values are stored as modifying parameters in the parameter memory.

### (iv) The Fourth Embodiment of Computation of Modifying Parameters

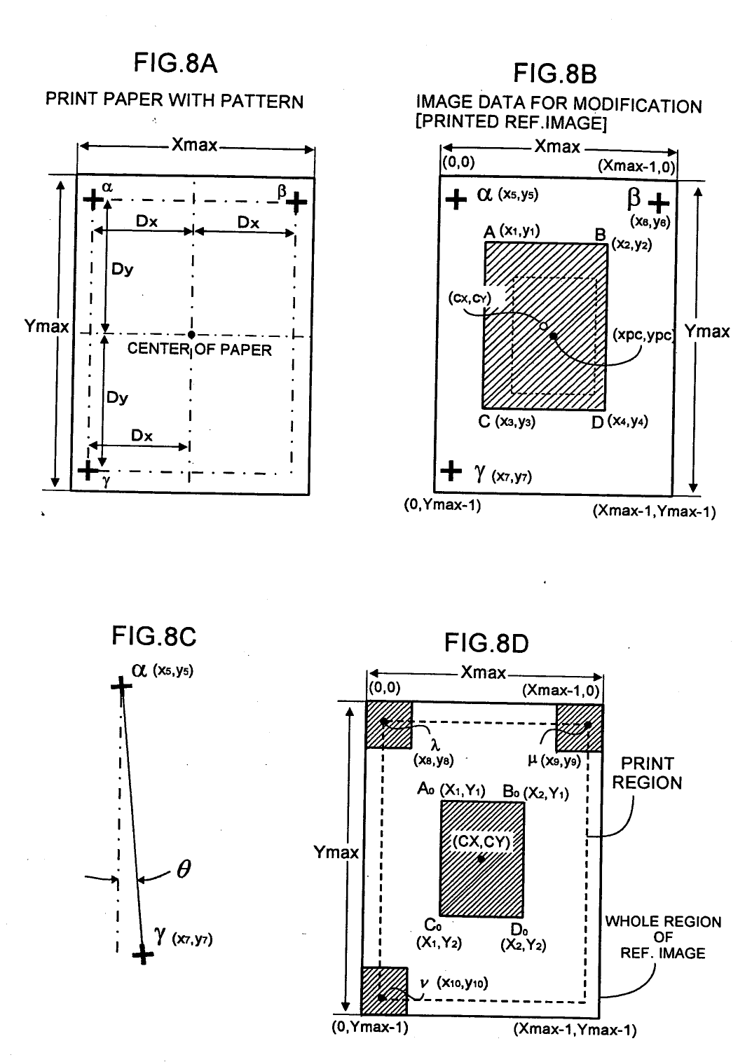

As one more other embodiment of computation of modifying parameters, an image data for modification may be generated by printing a reference image of either of the first to the third embodiments with the printer 2 on a printing sheet on which cross patterns have been positioned with high precision as shown in FIG. 8 (A), and by reading the printed image on the printing sheet having the precisely positioned cross patterns (FIG. 8 (B)) into an image reading device 1. According to this embodiment, the analysis of an image data for modification can be conducted while taking into account any inclination and deviation of the paper sheet carrying the printed image upon setting to the reading region of the image reading device 1 for reading the printed image of the reference image therewith.

Referring to FIG. 8 (A) or (B), for example, three cross patterns α, β, and γ each are positioned to a point, relatively near the three corners of the sheet, at predetermined distances Dx and Dy, precisely measured from the center of the sheet along X and Y directions, respectively. When the printed image of FIG. 8 (B) on which the cross patterns has been positioned is read into the image reading device 1 as an image data for modification, the acquired image data is converted into a binary image with the pattern and background being set to brightness values “1, 0”, respectively. Then, using the matrix M5 as shown in FIG. 6 (D), correlations of the images are computed in the neighborhood region of the respective cross patterns α, β, and γ through the similar way as explained for the first embodiment, and thereby, the coordinates of the center of the cross pattern, α(x5, y5), β(x6, y6), and γ(x7, y7) are determined.

When α, β, and γ are specified, the center position of the print sheet in the image data for modification (xpc, ypc) will be determined by:

xpc=(x6+x7)/2; ypc=(y6+y7)/2 (12)

Further, the inclination of the print sheet to the reading region of the image reading device 1 when the print sheet is set in the image reading device 1, namely, the inclination of the printed image in the image data for modification, may be determined using an angle specified between the line from α to γ and the Y direction (alternate long and short dash line) of the image data for modification as shown in FIG. 8 (C), as follows:

θ=arctan ((x7−x5)/(y7−y5))

Then, through conversion of the coordinate system (x, y) of the image data for modification is converted into (x′, y′) by compensating the displacement (xpc−Xmax/2, ypc−Ymax/2) between the center of the printing medium and the center of the image data for modification, and by rotating the coordinate system by θ so as to make the line extending from α to γ coincide with the Y direction of the image data for modification, i.e.

x′=(x·(xpc−Xmax/2))·cos θ+(y−(ypc−Ymax/2))·sin θ

y′=−(x−(xpc−Xmax/2))·sin θ+(y−(ypc−Ymax/2))·cos θ (13),

the coordinates of a reference pattern (e.g. rectangular region ABCD) will be expressed with the coordinate system on the print sheet. Thus, using the coordinate values after this coordinate conversion, values of scaling factors and shifting amounts, etc. will be determined in the ways as explained in the above-mentioned embodiments, and stored in the parameter memory. Accordingly, through the above-mentioned coordinate conversion, modifying parameters will be computed using the coordinates on the printing medium, so that any error in the set position of the print image of the reference image when a user sets it on the image reading device 1, namely, misalignment of the printing medium to the reading region of the image reading device can eliminated. In this regard, although the cross patterns are used in the present embodiment, it should be understood that equivalent effects also are obtained with the other patterns, and such a case is included in the scope of the present invention.

### (v) The Fifth Embodiment of Computation of Modifying Parameters

As further embodiment, a reference image with which “patches” of an appropriate size (which should not be entirely removed from a printed image) are provided in the corners as shown in FIG. 8 (D) may be used. When the reference image as in FIG. 8 (D) is passed through the printer 2, only the interior of the rectangular region, indicated as the print region shown by dotted line, is printed on a printing medium, together with parts of the patches in the corner thereof. Thus, if the reading region of the image reading device 1 is larger than the printing medium, the region of the printing medium in the image data for modification can be determined by detecting the position of the patches printed in the corners of the printing medium. The coordinates of the vertices, λ(x8, y8), μ(x9, y9), and ν(x10, y10) of the patches corresponding to the corners of the printing medium can be detected by computing correlation Cr used for detecting the vertices of the rectangular region in the first embodiment. When the coordinates of the image data for modification are converted, using the coordinates of the vertices λ, μ and ν, while assuming λ as the origin of the coordinates, the image data are specified with the coordinates employing the corner at the upper left of the printing medium as the origin, and in the analysis of a predetermined pattern of the image data for modification, any error of a set position of the printed image of the reference image when a user sets it in the image reading device 1 can be eliminated. In this regard, although the rectangular region in the first embodiment is drawn in FIG. 8 (D), the pattern of the second or third embodiment may be employed.

### Layout Composing

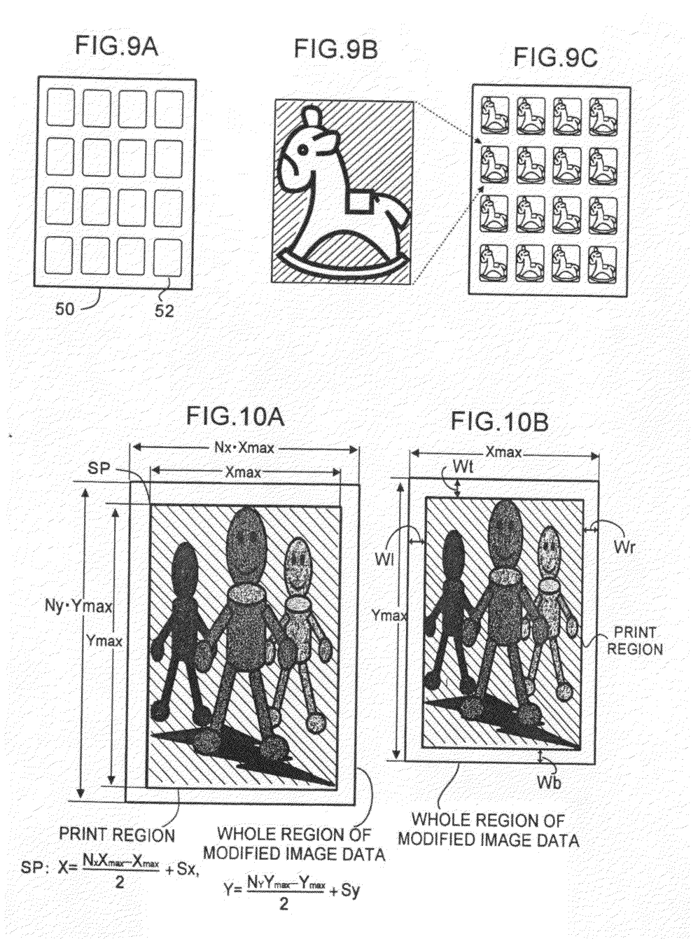

In the normal mode of the inventive image reading device 1, an original image can be printed not only with the same dimension as its original size (as it is read with the scanner portion), but also with arbitrary various layouts (an arranged image data). For example, an original image may be printed in “multiple attachment printing” mode, where a seal paper 50, as shown in FIG. 9 (A), having a plurality of cut frames 52 (for example, 4, the 9, 16 frames, etc.), is prepared and an original image (FIG. 9 (B)) is printed so as to be fit into the respective frames (FIG. 9 (C)). Each of the frames can be removed to be used as a seal or a sticker. Alternatively, a predetermined margin or unfilled space may be attached with the circumference of an original image (“printing with a margin”). Preferably, it is programmed in the inventive device that a user can select a favorite one from several layouts prepared previously.

When an original image is printed with a certain layout selected by a user instead of printing the original image with the same dimension as it is read with the scanner portion, an image data of a solid color is prepared in the layout composing portion 10e. The solid colored image data may have a brightness value RGB (255,255,255) for all pixels and a predetermined dimension, e.g. the number of pixels X×Y. Then, in the layout composing portion 10e, the original image data is pasted on predetermined regions (the original image data is arranged.) in the solid colored image data. In the case of “multiple attachment printing”, for instance, when the seal paper of FIG. 9 (A) is used, the position corresponding to the region of each frame of the seal paper is predetermined in the solid color image data. Thus, an original image data read with the image reading device 1 is shrunk in a way known in the art so as to be accommodated within the respective frames of the seal paper, and pasted on the respective sites of the frames (The brightness value of each pixel in each frame is replaced). Further, in the case of printing with a margin (not shown), the margin of a predetermined width is defined in an image data of solid color and an original image data is expanded or shrunk appropriately so as to be fit into the region surrounded by the margin. In this regard, in multiple attachment printing or printing with a margin, an arbitrary color may be applied on a region used as unfilled space. In such a case, the RGB values of a solid or plain image data may be changed into arbitrary values. For one skilled in the art, it should be understood that, through the above-mentioned processing, an arranged image data having an arbitrary layout can be created, and such a case is included in the scope of the present invention.

By the way, when an original copy is set in the image reading device 1, it is possible that the position of the original copy deviates from the reading region of the image reading device, or the size of the original copy is sometimes smaller than the reading region. In such a case, the edge of the original copy may appear, like a shadow, in the image data acquired in the image reading device. Then, in order to avoid such an appearance of the edge of an original copy, an acquired original image data may be trimmed by cutting off its periphery at a predetermined width in the layout composing portion 10e (Trimming processing). Typically, it is preferable that the trimming processing is conducted prior to sending the whole original image data to the image modification portion 10a, or prior to executing the layout composing for the above-mentioned multiple attachment printing or printing with margin.

### Generation of Modified Original Image Data

In the normal mode of the inventive image reading device 1, an original image data or an arranged image data (created with a certain layout from original image data in the layout composing portion 10e) is modified in the image modification portion 10a by means of modifying parameters to generate a modified original image data so as to print an image on a printing medium with a layout desired or requested by a user. In a modified original image data, an original image data or an arranged image data is assigned to the print region of the modified original image data through either of manners explained below. As noted, when the printer 2 receives a modified original image data and performs the printing in the margin-less printing mode programmed in the printer 2, the image represented by the whole modified original image data is set so as to extend beyond a printing medium by a predetermined width in accordance with the internal setting of the printer 2, and therefore, the print region of the modified original image data is rendered to coincide with the printing medium, resulting in that an image of a size or a layout desired or requested by a user, assigned in the print region, will be printed on the printing medium.

With respect to generation of modified original image data, the inventive image reading device 1 may be designed to conduct three printing modes, e.g. “Just-fit printing mode”, “margin-less printing mode”, “printing-with-margin mode”. Hereafter, the processes of generating modified original image data in the respective modes are explained.

### (i) Just-Fit Printing Mode

In Just-fit printing mode, the whole region of an arranged image data or an original image data is assigned so as to be just fit into the print region of a modified original image data. Thus, when the modified original image data is transmitted to the printer 2, the whole region of the arranged image data or original image data will be printed on a printing medium so as to substantially coincide with the whole area of the printing medium.

In a manner of generating such a modified original image data in the just-fit printing mode, first, a pasteboard image data defining the whole region of a modified original image data may be prepared. In order to generate a modified original image data without reducing a resolution of an arranged image data or an original image data having the dimension of Xmax×Ymax, the dimension of the pasteboard image data is set to N_{X}·Xmax×N_{Y}·Ymax as shown in FIG. 10 (A). Then, taking shifting amounts Sx and Sy into account, the arranged image data or original image data is pasted within the inside of the rectangular region actually appearing in a printing medium within the pasteboard image data, as indicated with “print region” in the drawing. More specifically, when the dimension of a modified original image data is N_{X}·Xmax×N_{Y}·Ymax, its print region is ranged in a pasteboard image data,

for X direction,

from (N_{X}·Xmax−Xmax)/2+Sx to (N_{X}·Xmax+Xmax)/2+Sx, (14a)

and,
for Y direction,

from (N_{Y}·Ymax−Ymax)/2+Sy to (N_{Y}Ymax+Ymax)/2+Sy (14b).

Accordingly, a modified original image data is generated by putting the brightness values of the whole region of an arranged image data or an original image data on the region in the pasteboard image data specified above with the range of X and Y directions while setting the coordinates [x, y]=[(N_{X}·Xmax−Xmax)/2+Sx, (N_{Y}Ymax−Ymax)/2+Sy] as the starting point SP. Further, according to the third embodiment of computation of modifying parameters, since the widths of the upper, lower, left side and right side periphery portions being cut off in an image data received by the printer 2 can be directly obtained, a modified original image data may be generated by inserting an arranged image data or an original image data into a rectangular region defined by the following four points: (N_{X}−Wl, N_{Y}·Wt), (N_{X}·(Xmax−Wr), N_{Y}·Wt), (N_{X}·Wl, N_{Y}·(Ymax−Wb)), (N_{X}·(Xmax−Wr), N_{Y}·(Ymax−Wb)), in a pasteboard image data of N_{X}·Xmax×N_{Y}·Ymax.

On the other hand, when making the dimension of a pasteboard image data equal to the dimension Xmax×Ymax of a reference image data, as shown in FIG. 10 (B), a pasteboard image data of dimension Xmax×Ymax is prepared. A modified original image data is generated by shrinking an arranged image data or an original image data into the dimension of (Xmax/NX)×(Ymax/NY), and by pasting on the region specified in the expressions (7 a, b) as indicated with “PRINT REGION” in the drawing. Further, according to the third embodiment of computation of modifying parameters, by means of the widths of the upper, lower, left side and right side periphery portions being cut off in an image data received by the printer 2, a modified original image data may be generated by shrinking an arranged image data or an original image data, and subsequently inserting the shrunk image data into the rectangular region defined by the following four points, (Wl, Wt), (Xmax−Wr, Wt), (Wl, Ymax−Wb), (Xmax−Wr, Ymax−Wb), in the pasteboard image data of Xmax×Ymax.

In this connection, it should be noted that, in the above-mentioned generation of a modified original image data as described above, in the case of N_{X}=N_{Y}=1, no modification of the image size will be carried out, and, in the case of Sx=Sy=0, no compensation for shifting amounts will be carried out. Depending upon the design of the image reading device 1 or a user's selection, only either one of modification by scaling factors and modification by shifting amounts may be conducted, and even such a case is included in the scope of the present invention.

In another manner of the just-fit printing mode, a modified original image data may be generated by attaching a frame data with the outside of the periphery of an arranged image data or an original image data. Widths of the frame to be added to the periphery portions in the four directions of the arranged image data or original image data can be determined based on scaling factors N_{X} and N_{Y} and shifting amount Sx and Sy, or, in the case of the third embodiment of computation of a modifying parameter, based upon Wt, Wb, W1, and Wr (in the case of the third embodiment, if the dimension of modified original image data is Xmax×Ymax, the values of Wt, Wb, Wl, and Wr become the widths of a frame.). The resultant modified original image data is identical to those in the case of using the pasteboard image data, but, it is advantageous in that less memory amount is required during the operation of image data because no memory for pasteboard image data is required.

It should be noted that, in both of the image data (FIG. 10 (A), (B)) generated as described above, the dimension of the whole modified image data is N times (scaling factor) as large as the dimension of the corresponding print region. Thus, when this modified image data is transmitted to a printer 2 and printed therein, the number of pixels per unit length of the image data on a printing medium is set so as to make the whole image of the modified original image data extend beyond a printing medium by a predetermined width, namely, so as to render the whole image of the modified original image data to be N times larger than the printing medium, resulting in that the dimension of the print region (1/N of the dimension of the modified original image data) on which an arranged image data or an original image data is pasted becomes equal to the dimension of the printing medium. Further, with consideration of the deviation of the center of the whole region of an image represented by an image data from that of a printing medium upon printing with the printer 2, the center position of the print region in an modified original image data is made shifted, by the shifting amounts, Sx, Sy in FIG. 10(A) and Sx/Nx, Sy/Ny in FIG. 10(B), from the center position of the modified original image data, resulting in that the center positions of the print region and the printing medium coincide with each other in the resultant printed image.

### (ii) Margin-Less Printing Mode

In the just-fit printing mode as described above, the region read with the image reading device can be printed so as to coincide with a printing medium. However, on setting an original copy in the image reading device 1, it is possible that the position of an original copy deviates from the reading region of the image reading device, or that the dimension of an original copy is sometimes smaller than the reading region. In such cases, the edges of the original copy may appear in the read image data like a shadow. In addition, in the printer 2, it is very difficult to completely control the accuracies of the size of print papers, of the position of a print paper set on the printer 2 by a user and of the paper feeding, so that unfilled space unintended by a user may appear in the periphery portion of a printing medium when the print sheet is larger than a regular size; when a print sheet is put on the position deviating a regular position in a paper feed tray; and when a paper sheet during its feeding is inclined from its regular feeding course.

Thus, in the inventive image reading device, in order to avoid such appearances of edges of an original copy or unintentional appearance of a margin in the image data, “Margin-less printing mode” may be executed such that the whole region of an arranged image data or an original image data can be printed so as to extend beyond a printing medium by a predetermined width, resulting in that the printing will be applied on the outermost edge of the printing medium.

Referring to FIG. 11 (A), in the margin-less printing mode, when an arranged image data or an original image data of dimension, Xmax×Ymax, extends, by width E, beyond the right and left edges of a print region in an image to be transmitted, the width of the arranged image data or original image data extending beyond the upper and lower edges of the print region is determined as E·Ymax/Xmax under a condition that the aspect ratio of an image does not vary.

When an arranged image data or an original image data is transmitted without changing its resolution, the dimension of a modified original image data transmitted to the printer 2 will be set to:

N_{X}·(Xmax−2E), for X direction; and

N_{Y}·(Ymax−2 E·Ymax/Xmax) for Y direction.

Accordingly, the dimension of the print region is:

(Xmax-2E), for X direction; and

(Ymax−2 E·Ymax/Xmax), for Y direction.

When the print region of this dimension is printed on a printing medium, the center of the printing medium will be shifted, by shifting amount Sx and Sy, from the center of the image data, so that the distance between the center of the modified original image data and the center of the print region in the coordinate system of the modified original image data will be the (Xmax−2E)/Xmax times of shifting amounts Sx and Sy, namely, given by: (1−2E/Xmax)·Sx, (1−2E/Xmax)·Sy. Accordingly, when the arranged image data or original image data of dimension Xmax×Ymax is pasted on the modified original image data with starting from the coordinate:

X=(N_{X}·(Xmax−2E)−Xmax)/2+(1−2E/Xmax)·Sx,

Y=(N_{Y}·(Ymax−2E·Ymax/Xmax)−Ymax)/2+(1−2E/Xmax)·Sy (15),

the arranged image data or original image data in the rectangular region, indicated as the “print region” in the figure, will be printed on the printing medium in which the arranged image data or original image data extends, by E, beyond the left and right edges, and, by E·Ymax/Xmax, beyond the upper and lower edges of the printing medium.

In generating these modified original image data, an arranged image data or an original image data may be pasted on a pasteboard image data of the above-mentioned dimension, or, a frame data may be attached with around the periphery of an arranged image data or an original image data. In the case of attaching a frame data, if using the width data Wt, Wb, Wl, and Wr of the periphery portion of the image data cut off by the printer 2 obtained in the third embodiment of computation of modifying parameters, the widths of those values multiplied by N_{Y} (1−2 E/Xmax) or N_{X} (1−2 E/Xmax) are attached to the corresponding peripheries of the image data.

Further, when the dimension of a modified original image data to be transmitted is made the same as the dimension Xmax×Ymax of the image obtained by the reading of an image reading device 1, an arranged image data or an original image data is multiplied by 1/{N_{X}(1−2E/Xmax)} and 1/{N_{Y}(1−2E/Xmax)} for X and Y directions, respectively, (the image data is shrunk), and inserted into the modified original image data with starting from the coordinates obtained by multiplying the values in the expression (15) with 1/{N_{X}(1−2E/Xmax)} and 1/{N_{Y}(1−2E/Xmax)}, respectively. In the above-mentioned series of processes, a modified original image data may be generated, taking into account only either of scaling factor and shifting amounts for the printer 2, and such a case is included in the scope of the present invention.

“Margin-less printing mode” explained above is conducted in a way similar to a margin-less printing mode of a printer in which the image data received by the printer is printed while being made extend beyond a printing medium in accordance with the internal setting of the printer. However, in the case of margin-less printing mode of a printer, the width of a periphery portion being cut off cannot be adjusted by a user, and varies with models and/or setting of printers. On the other hand, according to the “margin-less printing mode” in the inventive image reading device, the width of a periphery portion being cut off can be controlled at a constant irrespective of the internal setting of the printers. In addition, as explained about later in the description of “Operating the Operation panel”, the width E of a cut-off periphery portion in accordance with the setting of the image reading device may be adjustable by a user. The adjustment of the width of a periphery portion by a user may be conducted so as to render the ratio of the dimension of a modified original image data to the dimension of an original image data or an arranged image data to be in the range of larger than 1 but below a scaling factor.

(iii) Printing-with-Margin Mode

In the inventive image reading device 1, in generation of a modified original image data, a margin or space may be provided to a periphery portion of a printed image. Such a margin or space may be added by generating an arranged image data from an original image data in the layout composing portion and printing the arranged image data in the just-fit printing mode. However, for example, when a layout composing portion is omitted in the device 1, a margin or space may be provided through the setting in the image modification portion 10a.

Referring to FIG. 11 (B), upon generating a modified original image data, when a margin of width F is provided to the right and left of the printed image of an arranged image data or an original image data of dimension Xmax×Ymax, the upper and lower widths become F·Ymax/Xmax. The dimension of a modified original image data and the position of an arranged image data or an original image data therein may be obtained by substituting E with −F in the expressions shown in the explanation of Margin-less printing mode. In addition, in generation of a modified original image data, an arranged image data or an original image data may be pasted on an appropriate position in a pasteboard image data as prepared above, or, may be provided with a frame data. In either case, in the resultant modified original image data, the region which actually appears on a printing medium is in the rectangular region indicated as the “print region” in the drawing, and thus, unfilled space or margin of F or F·Ymax/Xmax will be generated on the periphery portion of the arranged or original image data. Further, the width of a margin given by the image reading device may be adjustable through setting by a user as explained about later in the description of “Operating the Operation panel”.

### Operating the Operation Panel

FIG. 12 (A) shows an example of the operation panel 20 provided on the surface of the image reading device 1. Referring to the drawing, on the operation panel 20, provided are Power button 100 for powering ON/OFF of a power source of the device 1; Start button 102 for commanding the device 1 to start the reading and printing of an image, Stop button 104 for commanding the device 1 to stop or cancel the reading and printing of an image, Digital display portion 108 which displays the printing number of sheets, an operation mode of the image reading device 1, layout mode, printing mode, etc., Selection switches 110a and 110b for changing the print number of sheets, selection of a layout, etc. and Setting change button 112 for changing a current setting in various setting items. Further, an alarm lamp for telling the abnormalities of a printer 2, the absence of modifying parameters, etc. may be provided (not shown).

As noted, the image reading device 1 operates selectively at least in the two modes, calibration mode and normal mode. For instance, under a condition that the image reading device 1 is not turned on, when Power button 100 is pushed, the operation mode of the image reading device 1 may be set to the normal mode, and, when Power button 100 and another arbitrary button are pushed simultaneously, the operation mode of the device 1 may be set to the calibration mode. For example, when the calibration mode is selected, the character of “CALIBRATION MODE” is displayed in the digital display portion 108 (FIG. 12B).

Operation in the calibration mode is started by pushing Start button 102. When the start button 102 is pushed, a reference image data is automatically transmitted to the printer 2 from the image reading device 1, and printed by the printer 2. Subsequently, after the printed image of the reference image is set in the image reading device 1, when the start button 102 is pushed again, the printed image of the reference image will be read, an image data for modification will be generated, and computation of modifying parameters as explained above will be conducted automatically. The resultant parameters will be stored in the parameter memory. After the above processing is completed, the operation mode may be changed to the normal mode. In this connection, computation of modifying parameters in the calibration mode may be performed through either way of the above-mentioned embodiments. The way of computation of modifying parameters may be determined in the manufacture and adjustment of the device 1, or may be selectable by a user during the use of the device 1. As shown above, basically, in the calibration mode, what a user has to do are pushing Start button 102; and setting the printed image of the reference image to the device 1.

When the image reading device 1 is set in the normal mode, the digital display portion 108 displays “NORMAL MODE” and information about setting items. Change of setting items may be conducted by pushing Setting change button 112, and the selection in a certain setting item may be conducted by pushing either of Selection switches 110a and 110b.

If the image reading device 1 shifts into the normal mode, for example, first, Setting of the printing number of sheets may selected and the printing number of sheets may be displayed on the digital display portion 108. In this condition, the printing number of sheets is changed by pushing either of the selection switches 110a and 110b. (FIG. 12C)

Then, by pushing Setting change button 112, Layout setting is selected, and a currently selected layout selected may be displayed on the digital display portion 108. Change of the layout to be selected is made by pushing selection switches 110a and 110b, and whenever the selection switch is pushed, the digital display portion 108 will change. For instance, “All Margin-less Printing”—Original image data is printed in the above-mentioned margin-less printing mode (FIG. 12D). (It is not the margin-less printing according to the internal setting of the printer 2.) “All Printing with Margin”—A margin is printed around an original image data (FIG. 12E). “16 images patched printing”—16 of one original image are printed with the layout as shown in FIG. 9 (C). (Just-fit printing mode is set up automatically. FIG. 12 F.) In this regard, other layouts may be prepared appropriately and made selectable.

When “All margin-less printing” or “All printing with margin” is selected, if Setting change button 112 is pushed, adjustment of the width of the cut-off periphery portion or the margin added to the periphery becomes available. For instance, if the button 112 is pushed, “k0” (or “F0”) is first displayed on the digital display portion 108, indicating that the cutoff width (or margin width) is 0 mm, in which the acquired original image is printed in the just-fit printing mode. Then, whenever the selection switch 110a or 110b is pushed, the setting of width is changed subsequently to 1 mm, 2 mm, - - - , 9 mm, while the digital display portion 108 changes correspondingly to “k1”, “k2”, - - - “k9” (or “F1”, “F2”, - - - , “F9”).

Furthermore, when Setting change button 112 is pushed, the other setting item is selected, the change of setting in each item may be made by pushing the selection switch 110a or 110b while showing the setting value on the digital display portion 108.

Reading and printing of an original image are conducted by pushing a start button 102. When start button 102 is pushed, the image reading device reads in an original image, generates an original image data representing the original image, and subsequently modifies the original image data in accordance with various settings as mentioned above and using modifying parameters, and outputs the resultant modified original image data to the printer 2, as described so far. The printer 2, according to the internal setting thereof, prints an image corresponding to the received modified original image data on a printing medium. However, since the modified original image data are prepared so that an original image data or an arranged image data may appear on a printing medium with a desired or requested size or a desired or requested layout, a printed image will be obtained as expected by a user, irrespective of the internal setting of the printer 2.

1. An image reading device for reading an image, generating and outputting an image data representing the image, the device comprising:
an image detecting portion which optically reads an original image on an original copy and generates a signal representing the original image;
an image data generating portion which generates an original image data based on the signal representing the original image;
an image data outputting portion which outputs an image data with a communication mode which enables a printer supporting a predetermined communication standard to receive the image data and to print an image represented by the image data; and
an image modification processing portion which modifies the original image data based upon an image data for modification generated with the image data generating portion through reading a printed reference image with the image detecting portion, the printed reference image being printed on a printing medium with the printer to which a reference image data representing a reference image including a predetermined pattern is outputted from the image data outputting portion;
wherein the image data outputting portion selectively outputs a modified original image data generated by modifying the original image data with the image modification processing portion to render a printed image corresponding to the original image to be printed with a desired size or a desired layout on a printing medium.

2. A device of claim 1, wherein the reference image data is stored in a reference image data storage portion.

3. A device of claim 1, wherein the reference image data is generated by reading a reference image original copy with the image detecting portion.

4. A device of claim 1, wherein the image modification processing portion detects a region printed on the printing medium with the printer in the reference image represented by the reference image data outputted from the image data outputting portion based on the reference image data and the image data for modification, and modifies the original image data based on information of the detected region.

5. A device of claim 4, wherein the image modification processing portion modifies the original image data based upon a ratio between a dimension of the reference image data outputted from the image data outputting portion and a dimension of an image data corresponding to the region printed on the printing medium with the printer in the reference image data.

6. A device of claims 4, wherein the image modification processing portion modifies the original image data based upon a position of the region printed on the printing medium with the printer in the reference image represented by the reference image data outputted from the image data outputting portion.

7. A device of claim 1, wherein the image modification processing portion modifies the original image data based upon a dimension of the predetermined pattern in the reference image and a dimension of a pattern in an image represented by the image data for modification corresponding to the predetermined pattern.

8. A device of claim 1, wherein the image modification processing portion modifies the original image data based upon a position of the predetermined pattern in the reference image and a position of a pattern in an image represented by the image data for modification corresponding to the predetermined pattern.

9. A device of claim 1, wherein a dimension of the reference image data is substantially equal to a dimension of an image data generated with the image data generating portion through reading an image with the image detecting portion.

10. A device of claim 1, wherein the image modification processing portion computes a scaling factor based upon a dimension of the predetermined pattern in the reference image and a dimension of a pattern in an image represented by the image data for modification corresponding to the predetermined pattern, the scaling factor being a ratio between the dimension of the predetermined pattern in the reference image and a dimension of a pattern in the printed reference image corresponding to the predetermined pattern, and the image modification processing portion modifies the original image data based upon the scaling factor to render the printed image corresponding to the original image to be printed with the desired size.

11. A device of claim 1, wherein the image modification processing portion computes, based upon a position of the predetermined pattern in the reference image and a position of a pattern in an image represented by the image data for modification corresponding to the predetermined pattern, a shifting amount between the position of the predetermined pattern in the reference image and a position of a pattern in the printed reference image corresponding to the predetermined pattern, and the image modification processing portion modifies the original image data based upon the shifting amount to render the printed image corresponding to the original image to be printed in a desired position.

12. A device of claim 1, wherein the predetermined pattern has a dimension such that a whole of the predetermined pattern is accommodated within the printed reference image.

13. A device of claim 1, wherein the predetermined pattern has a dimension such that the predetermined pattern partially extends beyond the printed reference image.

14. A device of claim 13, wherein a width of a periphery portion of the reference image being cut off from the image data for modification is calculated based upon a size of a portion of the predetermined pattern extending beyond the printed reference image.

15. A device of claim 1, wherein the image modification processing portion generates a pasteboard image data, and generates the modified original image data by pasting the original image data on the pasteboard image data to render the printed image corresponding the original image to be printed with the desired size or the desired layout on the printing medium.

16. A device of claim 1, wherein the image modification processing portion generates the modified original image data by adding a frame data on a periphery of the original image data to render the printed image corresponding to the original image to be printed with the desired size or the desired layout on the printing medium.

17. A device of claim 1, wherein the original image data is shrunk in generating the modified original image data.

18. A device of claim 1, wherein the image modification processing portion selectively generates the modified original image data so as to render the printed image corresponding to the original image on the printing medium to be printed at the substantially same size as the original image.

19. A device of claim 1, wherein the image modification processing portion selectively generates the modified original image data so as to provide a periphery of the printed image corresponding to the original image with a margin.

20. A device of claim 1, wherein the image modification processing portion selectively generates the modified original image data so as to render an image corresponding to the original image to be printed at multiple sites on the printing medium.

21. A device of claim 1, wherein the image modification processing portion selectively generates the modified original image data so as to cut off a predetermined width of a periphery portion of the original image from the printed image corresponding to the original image.

22. A device of claim 10, wherein the image modification processing portion selectively generates the modified original image data so as to render a ratio of a dimension of the modified original image data to a dimension of the original image data to be larger than 1 and below the scaling factor.

23. A device of claim 1, further comprising a printer setting portion which sets up a size of a printing medium used in the printer and the number of dots of ink or toner per unit length upon printing.

24. A device of claim 1, the device selectively operating in a normal mode or a calibration mode; wherein, when the calibration mode is selected, the reference image data is outputted through the image data outputting portion and the image data for modification is generated through reading the printed reference image in the image detecting portion; and wherein when the normal mode is selected, the modified original image data obtained by modifying the original image data with the image modification processing portion is outputted through the image data outputting portion.

25. A device of claim 24, wherein, when the calibration mode is selected, modifying parameters required for generate the modified original image data from the original image data based upon the image data for modification and the reference image data is automatically computed and memorized with the image modification processing portion, and wherein, when the normal mode is selected, the modified original image data is automatically generated from the original image data using the modifying parameters.

26. Image reading and a printing system comprising an image reading device for reading an image and generating an image data representing the image, and a printer connected to the image reading device, the printer receiving the image data and printing an image corresponding to the image data on a printing medium, wherein the image reading device comprising:
an image detecting portion which optically reads an image on an original copy and generates a signal representing the original image;
an image data generating portion which generates an original image data based on the signal representing the original image;
an image data outputting portion which outputs an image data to the printer; and
an image modification processing portion which modifies the original image data based upon an image data for modification generated with the image data generating portion through reading a printed reference image with the image detecting portion, the printed reference image being printed on a printing medium with the printer to which a reference image data representing a reference image including a predetermined pattern is outputted from the image data outputting portion;
wherein the image data outputting portion selectively outputs a modified original image data generated by modifying the original image data with the image modification processing portion to render a printed image corresponding to the original image to be printed with a desired size or a desired layout on a printing medium.
